(19) United States
(12) Patent Application Publication
(10) Pub. No.: US 2020/0296145 A1
(43) Pub. Date: Sep. 17, 2020

(54) COMMUNICATION TERMINAL, COMMUNICATION SYSTEM, AND DISPLAY CONTROL METHOD

(71) Applicants: Takeshi HORIUCHI, Tokyo (JP); Shigeru NAKAMURA, Kanagawa (JP); Yuichi KAWASAKI, Kanagawa (JP); Masashi OGASAWARA, Kanagawa (JP); Hiroshi HINOHARA, Kanagawa (JP); Takeshi HOMMA, Kanagawa (JP); Atsushi MIYAMOTO, Kanagawa (JP); Takafumi TAKEDA, Tokyo (JP)

(72) Inventors: Takeshi HORIUCHI, Tokyo (JP); Shigeru NAKAMURA, Kanagawa (JP); Yuichi KAWASAKI, Kanagawa (JP); Masashi OGASAWARA, Kanagawa (JP); Hiroshi HINOHARA, Kanagawa (JP); Takeshi HOMMA, Kanagawa (JP); Atsushi MIYAMOTO, Kanagawa (JP); Takafumi TAKEDA, Tokyo (JP)

(73) Assignee: Ricoh Company, Ltd.

(21) Appl. No.: 16/808,411

(22) Filed: Mar. 4, 2020

(30) Foreign Application Priority Data
Mar. 13, 2019 (JP) 2019-046139

(51) Int. Cl. H04L 29/06; G06F 3/14

(52) U.S. Cl. CPC H04L 65/4015; G06F 3/1454; H04L 65/403

(57) ABSTRACT

A communication terminal includes circuitry configured to: start a download of a plurality of stroke data items corresponding to a plurality of stroke images drawn at another communication terminal from a communication management system; receive capture image data obtained by capturing a display screen displayed at the another communication terminal by the another communication terminal, from an image storage device that stores the capture image data; when the download of the plurality of stroke data items is not completed, control a display of the communication terminal to display a capture image corresponding to the received capture image data; and when the download of the plurality of stroke data items is completed, control the display to switch an image to be displayed on the display from the capture image currently being displayed to the plurality of stroke images corresponding to the downloaded plurality of stroke data items.

### CROSS-REFERENCE TO RELATED APPLICATION

This patent application is based on and claims priority pursuant to 35 U.S.C. § 119(a) to Japanese Patent Application No. 2019-046139, filed on Mar. 13, 2019, in the Japan Patent Office, the entire disclosure of which is hereby incorporated by reference herein.

### BACKGROUND

### Technical Field

The present disclosure relates to a communication terminal, a communication system, and a display control method.

### Description of the Related Art

Communication systems are now in widespread use, which allows communication terminals at remote locations to communicate through a communication network such as the Internet. Examples of the communication systems include a conference system that performs a video conference. In a general conference system, a communication terminal used by one of parties involved in the videoconference converts an image or sound of a subject in a conference room into digital data and transmits the digital data to a communication terminal used by the other party. The communication terminal used by the other party displays an image on a display and outputs a sound from a speaker based on the received digital data. This enables to carry out a conference between remote locations, in a state close to an actual conference. Further, one communication terminal transmits image data indicating documents or the like being held or displayed on the one communication terminal to the other communication terminal through a communication network, to cause the image data to be shared between the communication terminals.

Furthermore, in recent years, communication terminals such as electronic whiteboards are widely used in companies, educational institutions, or government institutions. The electronic whiteboards display an image on a display and allows users to draw stroke images such as text, numbers, figures, or the like on the image. The communication terminal electronically converts content drawn by a user's operation of touching and moving an electronic pen or the user's hand on a surface of a display of the communication terminal, to generate stroke data such as coordinates data. The stroke image is rendered based on the stroke data. When a stroke image is drawn on one communication terminal, stroke data for reproducing the stroke image is transmitted to the other communication terminal through a communication network. The other communication terminal displays the same stroke image based on the received stroke data.

The techniques as describe heretofore enable one communication terminal to transmit stroke data for reproducing a stroke image as well as image data of documents such as documents (e.g., slides for presentation) that are stored in the communication terminal or that are currently being displayed at the communication terminal through a communication network. The other communication terminal on the receiving side displays a document image of the documents or a screen background as well as the stroke image. Still further, a technique is known that enables a communication terminal of a user who joins a remote conference part way through to receive stroke data already generated in the remote conference.

### SUMMARY

According to one or more embodiments, a communication terminal is communicable with another communication terminal. The communication terminal includes circuitry configured to: start a download of a plurality of stroke data items corresponding to a plurality of stroke images drawn at the another communication terminal from a communication management system that stores data to be shared between the communication terminal and the another communication terminal; receive capture image data obtained by capturing a display screen displayed at the another communication terminal by the another communication terminal, from an image storage device that stores the capture image data; when the download of the plurality of stroke data items is not completed, control a display of the communication terminal to display a capture image corresponding to the received capture image data; and when the download of the plurality of stroke data items is completed, control the display to switch an image to be displayed on the display from the capture image currently being displayed to the plurality of stroke images corresponding to the downloaded plurality of stroke data items.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a communication route, according to an embodiment of the present disclosure;

FIG. 2 is an illustration for explaining how an electronic whiteboard is used, according to an embodiment of the present disclosure;

FIG. 3 is a block diagram illustrating an example of a hardware configuration of the electronic whiteboard, according to an embodiment of the present disclosure;

FIG. 4 is a block diagram illustrating an example of a hardware configuration of a communication management system, a relay device, and an image storage device, according to an embodiment of the present disclosure;

FIG. 5 is a schematic diagram illustrating an example of a configuration of a communication system, according to an embodiment of the present disclosure;

FIG. 6A and FIG. 6B are block diagrams illustrating an example of a functional configuration of the communication system, according to an embodiment of the present disclosure;

FIG. 7 is a conceptual diagram illustrating an authentication management table, according to an embodiment of the present disclosure;

FIG. 8 is a conceptual diagram illustrating a terminal management table, according to an embodiment of the present disclosure;

FIG. 9 is a conceptual diagram illustrating a destination list management table, according to an embodiment of the present disclosure;

FIG. 10 is a conceptual diagram illustrating a session management table, according to an embodiment of the present disclosure;

FIG. 11 is a conceptual diagram illustrating a relay device management table, according to an embodiment of the present disclosure;

FIG. 12 is a conceptual diagram illustrating a stroke data management table, according to an embodiment of the present disclosure;

FIG. 13 is a conceptual diagram illustrating a storage location information management table, according to an embodiment of the present disclosure;

FIG. 14 is a sequence diagram illustrating operation for preparing to start remote communication between electronic whiteboards, according to an embodiment of the present disclosure;

FIG. 15 is a diagram illustrating an example of destination list displayed on the electronic whiteboard, according to an embodiment of the present disclosure;

FIG. 16 is a sequence diagram illustrating operation of starting remote communication, according to an embodiment of the present disclosure;

FIG. 17 is a sequence diagram illustrating operation for sharing document image data and stroke data, according to an embodiment of the present disclosure;

FIG. 18 is a sequence diagram illustrating operation for sharing document image data and stroke data, according to an embodiment of the present disclosure;

FIG. 19A is a diagram illustrating an example of a screen on the electronic whiteboard, according to an embodiment of the present disclosure;

FIG. 19B is a diagram illustrating an example of another screen on the electronic whiteboard, according to an embodiment of the present disclosure;

FIG. 19C is a diagram illustrating an example of another screen on the electronic whiteboard, according to an embodiment of the present disclosure;

FIG. 19D is a diagram illustrating an example of another screen on the electronic whiteboard, according to an embodiment of the present disclosure;

FIG. 20 is a sequence diagram illustrating operation of sharing document image data and stroke data with a communication terminal that joins part way through an on-going remote conference, according to an embodiment of the present disclosure;

FIG. 21 is a sequence diagram illustrating operation of sharing document image data and stroke data with a communication terminal that joins part way through an on-going remote conference, according to an embodiment of the present disclosure;

FIG. 22 is a sequence diagram illustrating operation of sharing document image data and stroke data with a communication terminal that joins part way through an on-going remote conference, according to an embodiment of the present disclosure;

FIG. 23 is a diagram illustrating an example of a screen in which a capture image is displayed on the electronic whiteboard, according to an embodiment of the present disclosure;

FIG. 24 is a diagram illustrating an example of a screen in which a document image and a stroke image are displayed on the electronic whiteboard, according to an embodiment of the present disclosure, and

FIG. 25 is a diagram illustrating an example how plural images are superimposed in a display image displayed on the electronic whiteboard, according to an embodiment of the present disclosure.

The accompanying drawings are intended to depict embodiments of the present disclosure and should not be interpreted to limit the scope thereof The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, one or more embodiments of the present disclosure is described with reference to the drawings.

Overview of Communication System:

Communication Route:

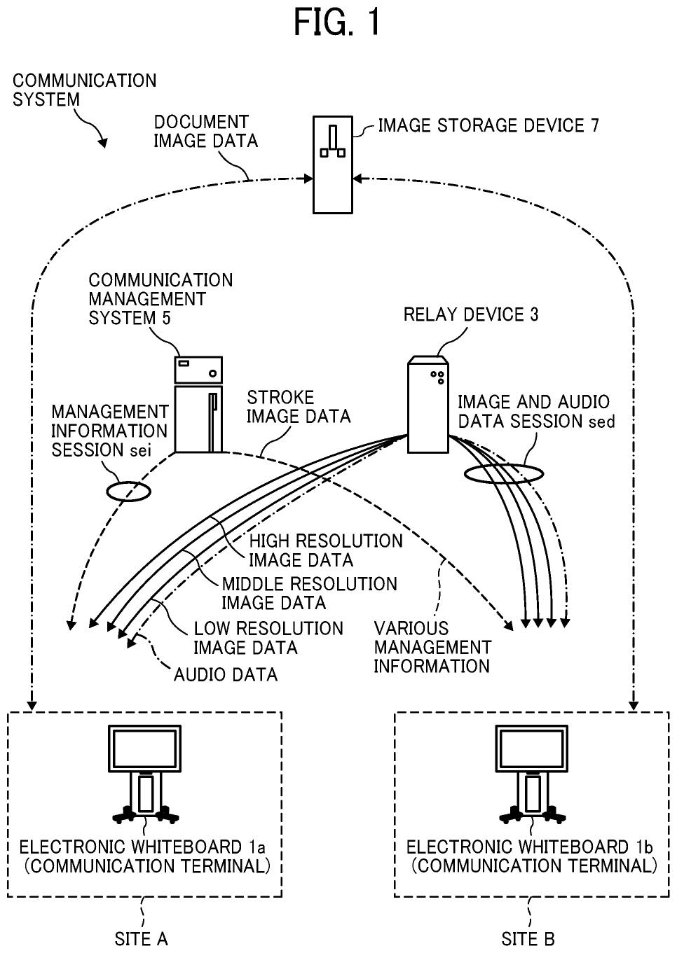

A communication system for conducting a videoconference between a plurality of electronic whiteboards including an electronic whiteboard 1a and an electronic whiteboard 1b while drawing images on the electronic whiteboards is described with reference to FIG. 1. FIG. 1 is a schematic diagram illustrating a communication route according to the present embodiment. The “videoconference” is sometimes called a “teleconference”. In this disclosure, a videoconference is described as an example, and other examples may be a meeting or a simple conversation.

The communication system includes a plurality of electronic whiteboard including the electronic whiteboards 1a and the electronic whiteboard 1b, a relay device 3, a communication management system 5, and an image storage device 7. The electronic whiteboard 1a and the electronic whiteboard 1b perform mutual communication of image data and audio data for calls and content data such as image data and stroke data for sharing. The stroke data is data necessary for reproducing a stroke image. The stroke data includes coordinate data, line width data, line color data, vector data, and the like. The electronic whiteboards 1a and the electronic whiteboard 1b exchange image data and audio data for a call with each other to reproduce an image and sound of a site where the communication counterpart resides, thereby making a remote video call. In this disclosure, an image of a site where each of the plurality of electronic whiteboards such as the electronic whiteboard la and the electronic whiteboard 1b reside may be referred to as a “site image”, hereinafter. Further, data for such site image may be referred to as “site image data”.

The electronic whiteboard 1a and the electronic whiteboard 1b exchange image data of a document image to be shared, thereby allowing participants using the communication system to share the same document image. The document image is an image displayed on the display of the electronic whiteboard 1. For example, the document image is an image of a documents for the conference such as presentation slides, and a background image displayed on the display. Further, the electronic whiteboard 1a and the electronic whiteboard 1b exchange stroke data of a stroke image, thereby allowing participants using the communication system to share the same stroke image. The stroke image is a line or the like drawn by a user with a handwritten stroke with an electronic pen or the like. The stroke image is displayed by stroke data indicating points that indicate coordinates on the display.

Although in the example of FIG. 1, the communication system includes the two electronic whiteboards, i.e., the electronic whiteboard 1a and the electronic whiteboard 1b, in another example, the communication system includes three or more electronic whiteboards. The electronic whiteboard 1a and the electronic whiteboard 1b are collectively referred to as an “electronic whiteboard 1” or “electronic whiteboards 1” hereinafter, to simplify the description, unless they need to be distinguished from one to another.

FIG. 1 illustrates an electronic whiteboard equipped with a videoconferencing function as an example of the electronic whiteboard 1a and the electronic whiteboard 1b. A site image according to site image data can be either a moving image or a still image.

In this disclosure, an electronic whiteboard that sends a request for starting a videoconference is referred to as a “source terminal”, and an electronic whiteboard as a request destination to which the request is to be transmitted is referred to as a “destination terminal”. In FIG. 1, the electronic whiteboard 1a is the source terminal and the electronic whiteboard 1b is the destination terminal. When the start of the videoconference is requested from the electronic whiteboard 1b, the electronic whiteboard 1b is the source terminal and the electronic whiteboard 1a is the destination terminal. Note that the electronic whiteboard 1a and the electronic whiteboard 1b may be used not only for communication between different offices or for communication between different rooms in the same office, but also for communication within the same room or for outdoor-indoor communication or outdoor-outdoor communication.

The relay device 3, which is implemented by one or more computers, performs a process of relaying content data for a call between the electronic whiteboard 1a and the electronic whiteboard 1b.

The communication management system 5 is implemented by one or more computers. The communication management system 5 centrally controls login authentication from the electronic whiteboard 1a and the electronic whiteboard 1b, the communication status of each of the electronic whiteboard 1a and the electronic whiteboard 1b, a destination list, the communication status of the relay device 3, and the like. Further, the communication management system 5 relays stroke data to be shared between the electronic whiteboard 1a and the electronic whiteboard 1b.

The image storage device 7, which is implemented by one or more computers, stores image data of a document image to be shared, the image data being uploaded from the electronic whiteboard 1a, and being downloaded to the electronic whiteboard 1b, and vice versa. In other words, the image storage device 7 stores the image data uploaded from the electronic whiteboard 1b, which is to be downloaded to the electronic whiteboard 1a.

In one example, each of the relay device 3, the communication management system 5, and the image storage device 7 is configured as a single computer. In another example, each of the relay device 3, the communication management system 5, and the image storage device 7 is configured as a plurality of computers to which one or more units (functions, means, or storages) are arbitrarily allocated. In other words, each of the relay device 3, the communication management system 5, and the image storage device 7 can be implemented by a plurality of servers that operate in cooperation with one another. In this example, the communication management system 5 and the image storage device 7 is configured as a server system 6 that controls data to be shared the electronic whiteboard 1a and the electronic whiteboard 1b. In the server system 6, the communication management system 5 and the image storage device 7 may be configured as a single computer.

In the communication system of FIG. 1, a management information session sei for exchanging various types of management information is established between the electronic whiteboard 1a and the electronic whiteboard 1b through the communication management system 5. In addition, four sessions are established between the electronic whiteboard 1a and the electronic whiteboard 1b to exchange four types of data including site image data of high resolution, site image data of medium resolution, site image data of low resolution, and audio data, through the relay device 3. In FIG. 1, these four sessions are collectively referred to as an image and audio data session sed. Note that the video and audio data session sed does not necessarily have to be four sessions and may have a smaller or larger number of sessions than the four sessions. In addition, a communication session may be established directly between the source terminal and the destination terminal without using the relay device 3. In still another example, the communication management system 5 can have functions of the relay device 3. In this example, the image and audio data session sed is established between the electronic whiteboard 1a and the electronic whiteboard 1b through the communication management system 5.

Further, in the communication system of FIG. 1, stroke data is exchanged between the electronic whiteboard 1a and the electronic whiteboard 1b using the management information session sei.

The description is now given of the resolution of an image of the site image data handled in the present embodiment. For example, the site image data of low resolution consists of 160 pixels in the horizontal direction and 120 pixels in the vertical direction. Such site image data of the low resolution is a base image. The site image data of medium resolution consists of, for example, 320 pixels in the horizontal direction and 240 pixels in the vertical direction. The site image data of high resolution consists of, for example, 640 pixels in the horizontal direction and 480 pixels in the vertical direction. In the case of a narrow band path, low-quality image data that only includes the site image data of low resolution as a base image is relayed. In the case of a relatively wide band path, intermediate-quality image data including the site image data of low resolution as a base image and the site image data of medium resolution is relayed. In the case of a very wide band path, high-quality image data including the site image data of low resolution as a base image, the site image data of medium resolution, and the site image data of high resolution is relayed. Since audio data is relatively small in data size compared with the site image data, the audio data is relayed even in the case of a narrow band path.

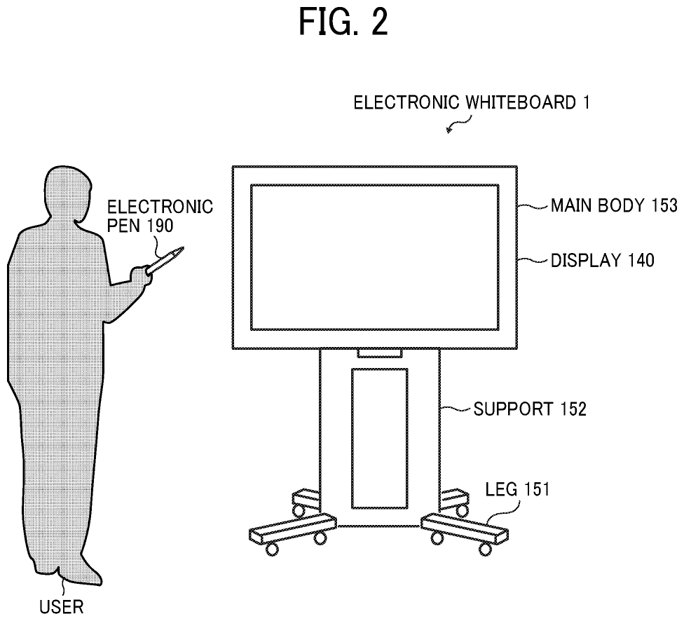

FIG. 2 is an illustration for explaining how an electronic whiteboard is used. As illustrated in FIG. 2, the electronic whiteboard 1 includes a plurality of legs 151 each having a plurality of casters on the lower side, a support 152 provided on the upper side of the legs 151, and a main body 153 provided on top of the support 152, and a display 180 provided on the front surface of the main body 153. The main body 153 includes a central processing unit (CPU) 101 and the like which is described below. The user can input (draw) a stroke image such as characters on the display 180 using an electronic pen 190.

Hardware Configuration:

A description is given hereinafter of a hardware configuration according to the present embodiment.

Hardware Configuration of Electronic Whiteboard:

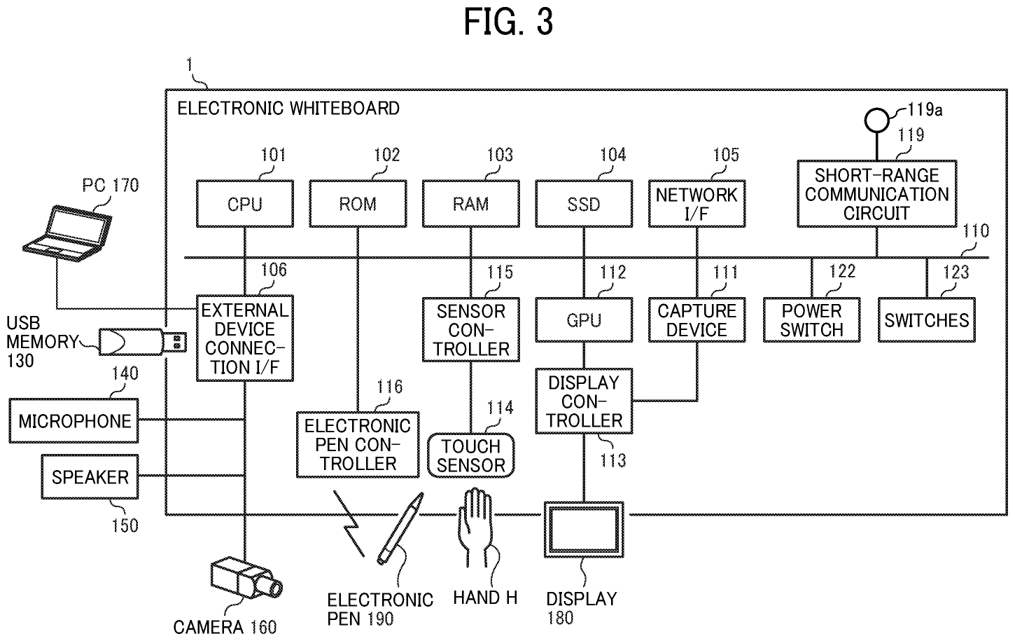

FIG. 3 is a block diagram illustrating an example of a hardware configuration of the electronic whiteboard 1, according to the embodiment. As illustrated in FIG. 3, the electronic whiteboard 1 includes a CPU 101, a read only memory (ROM) 102, a random access memory (RAM) 103, a solid state drive (SSD) 104, a network interface (I/F) 105, and an external device connection I/F 106.

The CPU 101 controls entire operation of the electronic whiteboard 1. The ROM 102 stores a control program for controlling the CPU 101 such as an initial program loader (IPL) to boot the CPU 101. The RAM 103 is used as a work area for the CPU 101. The SSD 104 stores various data such as a control program for the electronic whiteboard 1. The network I/F 105 controls communication with extraneous sources through a communication network 100. The external device connection I/F 106 is an interface for connecting the electronic whiteboard to various extraneous sources. Examples of the extraneous sources include a universal serial bus (USB) memory 130 and external devices (a microphone 140, a speaker 150, and a camera 160).

The electronic whiteboard 1 further includes a capture device 111, a graphics processing unit (GPU) 112, a display controller 113, a contact sensor 114, a sensor controller 115, an electronic pen controller 116, a short-range communication circuit 119, an antenna 119a of the short-range communication circuit 119, a power switch 122, and selection switches 123.

The capture device 111 displays image data (image information) as a still image or a moving image on a display of a computer (PC) 170, which is external to the electronic whiteboard 1. The GPU 112 is a semiconductor chip dedicated to graphics processing. The display controller 113 controls display of screens to output an image output from the GPU 112 to the display 180 or the like. The contact sensor 114 detects a touch onto the display 180 with the electronic pen 190 or a user's hand H. The sensor controller 115 controls operation of the contact sensor 114. The contact sensor 114 senses a touch input to a specific coordinate on the display 180 using the infrared blocking system. More specifically, the display 180 is provided with two light receiving elements disposed on both upper side ends of the display 180, and a reflector frame surrounding the sides of the display 180. The light receiving elements emit a plurality of infrared rays in parallel to a surface of the display 180. The light receiving elements receive lights passing in the direction that is the same as an optical path of the emitted infrared rays, which are reflected by the reflector frame. The contact sensor 114 outputs an identifier (ID) of the infrared ray that is blocked by an object (such as the user's hand) after being emitted from the light receiving elements, to the sensor controller 115. Based on the ID of the infrared ray, the sensor controller 115 detects a specific coordinate that is touched by the object. The electronic pen controller 116 communicates with the electronic pen 190 to detect a touch by the tip or bottom of the electronic pen 190 to the display 180. The short-range communication circuit 119 is a communication circuit that communicates in compliance with the near field communication (NFC), the Bluetooth (Registered Trademark), and the like. The power switch 122 turns on or off the power of the electronic whiteboard 1. The selection switches 123 are a group of switches for adjusting brightness, hue, etc., of display on the display 180, for example.

The electronic whiteboard 1 further includes a bus line 110. The bus line 110 is, for example, an address bus or a data bus, which electrically connects the elements such as the CPU 101 illustrated in FIG. 3.

The contact sensor 114 is not limited to the infrared blocking system type, and may be a different type of detector, such as a capacitance touch panel that identifies the contact position by detecting a change in capacitance, a resistance film touch panel that identifies the contact position by detecting a change in voltage of two opposed resistance films, or an electromagnetic induction touch panel that identifies the contact position by detecting electromagnetic induction caused by contact of an object to a display. In addition to or in alternative to detecting a touch by the tip or bottom of the electronic pen 190, the electronic pen controller 116 may also detect a touch by another part of the electronic pen 190, such as a part held by a hand of the user.

Hardware Configuration of Communication Management System, Relay Device, and Image Storage Device:

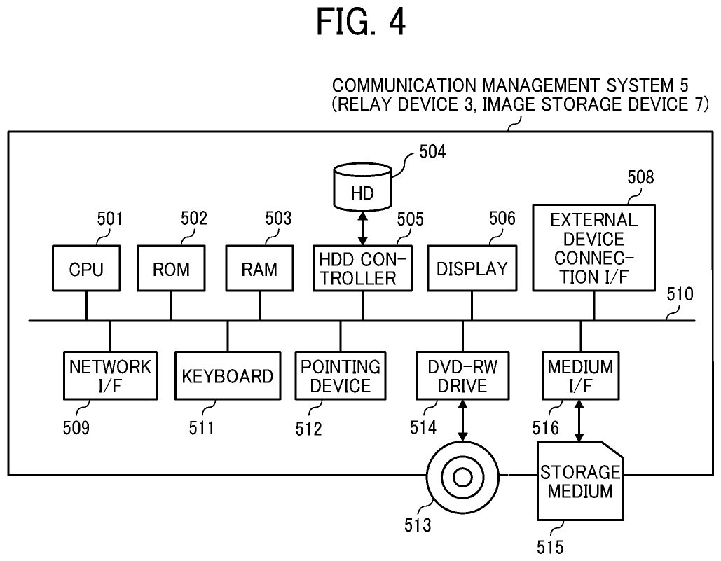

FIG. 4 is a block diagram illustrating an example of a hardware configuration of a communication management system 5, according to the embodiment. The communication management system 5 is implemented by, for example, one or more computers. The computer includes a CPU 501, a ROM 502, a RAM 503, a hard disk (HD) 504, a hard disk drive (HDD) controller 505, a display 506, an external device connection I/F 508, a network I/F 509, a keyboard 511, a pointing device 512, a digital versatile disc-rewritable (DVD-RW) drive 514, a medium I/F 516, and a bus line 510.

The CPU 501 controls entire operation of the communication management system 5. The ROM 502 stores a control program such as an IPL to boot the CPU 501. The RAM 503 is used as a work area for the CPU 501. The HD 504 stores various data such as a communication control program. The HDD controller 505 controls reading or writing of various data to or from the HD 504 under control of the CPU 501. The display 506 displays various information such as a cursor, menu, window, characters, or image. The external device connection I/F 508 is an interface that connects the computer as the communication management system 5 to various extraneous sources. The network I/F 509 is an interface for performing data communication using the communication network 100 such as the Internet. The keyboard 511 is one example of an input device (input means) provided with a plurality of keys for enabling a user to input characters, numerals, or various instructions. The pointing device 512 is an example of an input device (input means) that allows a user to select or execute a specific instruction, select a target for processing, or move a cursor being displayed. The DVD-RW drive 514 controls reading or writing (storing) of data to the DVD-RW. Alternatively, the DVD-RW drive 514 may control the reading or writing (storing) of data to a disc such as a Blu-ray (registered trademark) Disc Rewritable (BD-RE) instead of the DVD-RW drive. The medium I/F 516 controls reading or writing (storing) of data with respect to a storage medium 515 such as a flash memory.

The bus line 510 is an address bus, a data bus or the like, which electrically connects the elements illustrated in FIG. 4 such as the CPU 501.

The hardware configurations of the relay device 3 and the image storage device 7 illustrated in FIG. 1 are the same or substantially the same as the hardware configuration of the communication management system 5, and thus redundant description thereof is omitted below. The relay device 3, however, stores a relay control program in the HD 504 in alternative to the communication control program. In addition, the image storage device 7 stores an image storage control program in the HD 504 in alternative to the communication control program.

Overview of Configuration of Communication System:

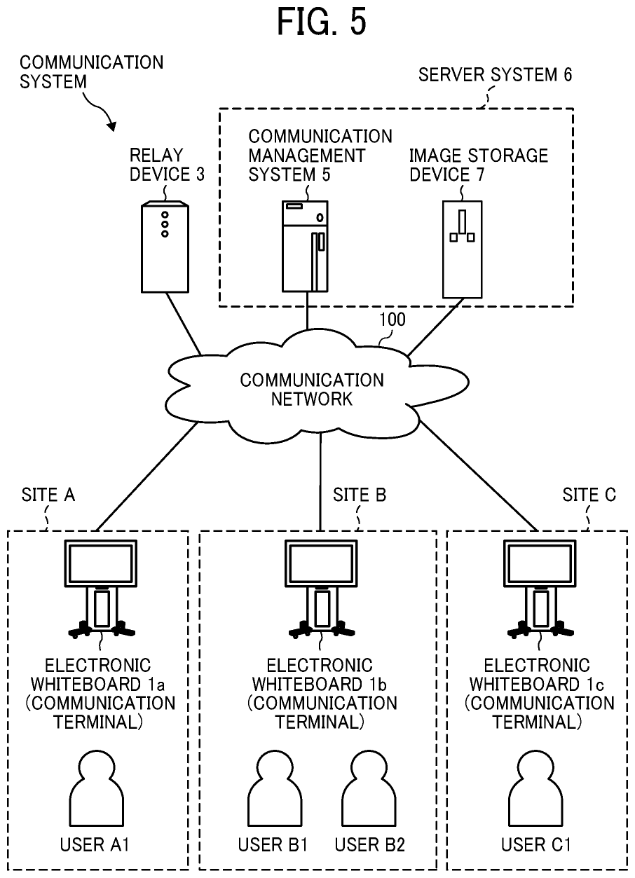

A description is now given of an overall configuration of the communication system according to embodiments of the present disclosure, with reference to FIG. 5. FIG. 5 is a schematic diagram illustrating an overview of the communication system according to embodiments of the present disclosure.

In FIG. 5, the electronic whiteboard 1a is provided at a site A, the electronic whiteboard 1b is provided at a site B, and an electronic whiteboard 1c is provided at a site C. For example, the site A is a Tokyo office in Japan, the site B is a Beijing office in China, and the site C is a Washington D.C. office in the United States. User A1 uses the electronic whiteboard 1a at the site A, Users B1 and B2 use the electronic whiteboard 1b at the site B, and User C1 uses the electronic whiteboard 1c at the site C.

The electronic whiteboard 1a, the electronic whiteboard 1b, the electronic whiteboard 1c, the relay device 3, the communication management system 5, and the image storage device 7 mutually communicate data through the communication network 100 such as the Internet. The communication network 100 may include a wireless network, in addition to a wired network.

The electronic whiteboard 1a, the electronic whiteboard 1b, and the electronic whiteboard 1c illustrated in FIG. 5 are electronic whiteboards configured to perform video communication.

Functional Configuration of Communication System:

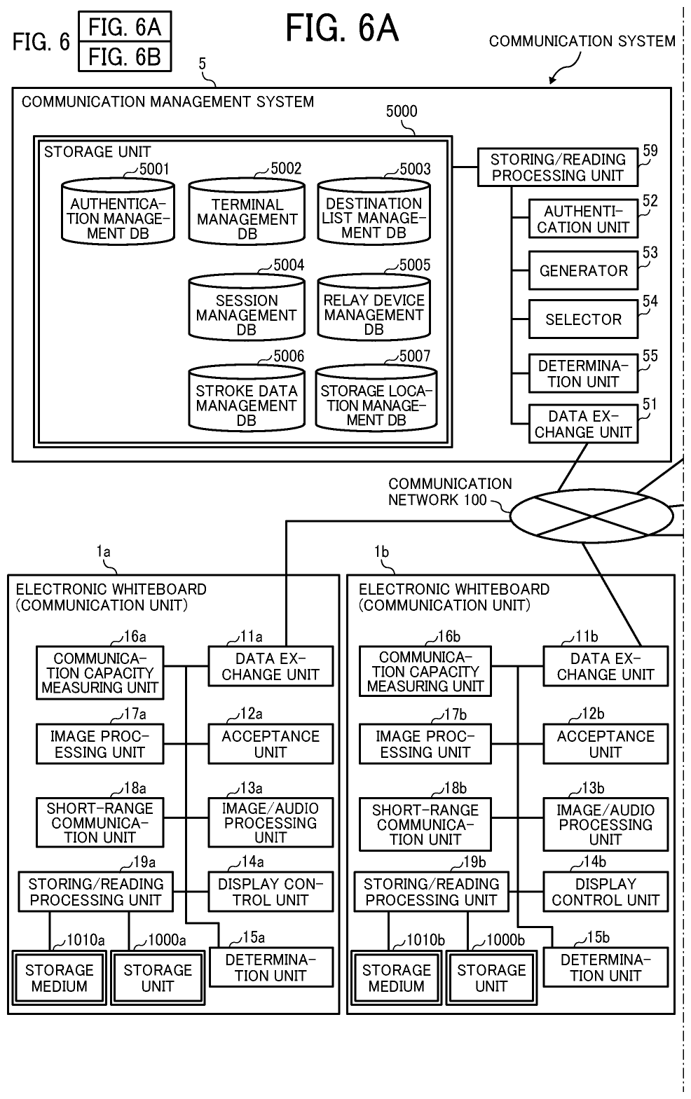

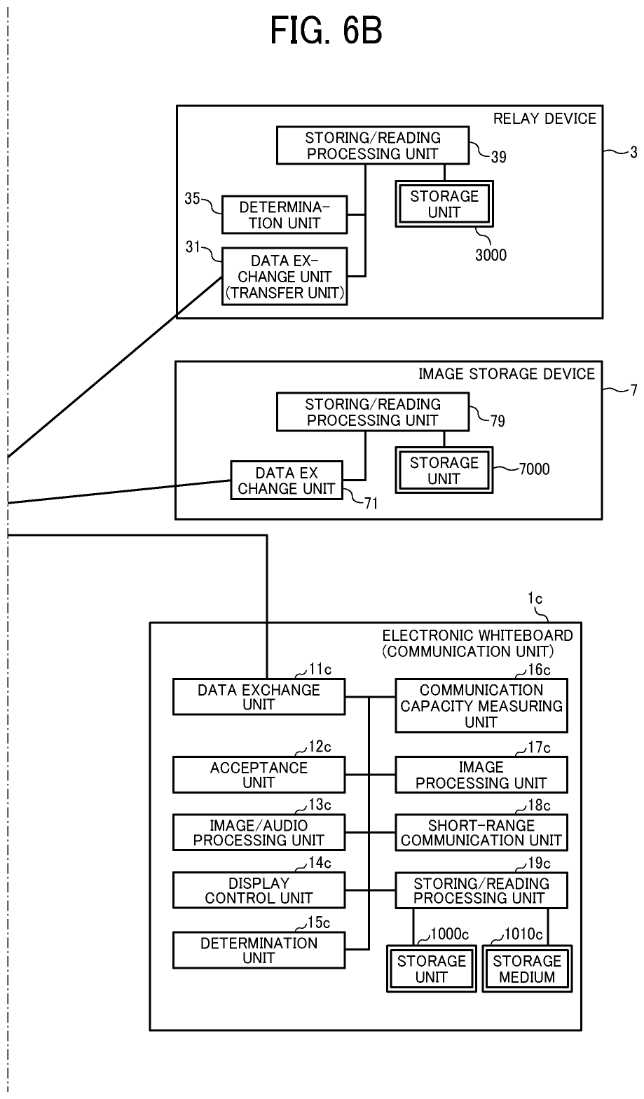

A description is now given of a functional configuration of the communication system according to embodiments of the present disclosure, with reference to FIG. 6A to FIG. 13. FIG. 6A and FIG. 6B are block diagrams illustrating an example of a functional configuration of the communication system according to embodiments of the present disclosure.

Functional Configuration of Electronic Whiteboard 1a:

As illustrated in FIG. 6A, the electronic whiteboard 1a includes a data exchange unit 11a, an acceptance unit 12a, an image/audio processing unit 13a, a display control unit 14a, a determination unit 15a, a communication capacity measuring unit 16a, an image processing unit 17a, a short-range communication unit 18a, and a storing/reading processing unit 19a. These units are functions implemented by or caused to function by operating any of the hardware elements illustrated in FIG. 3 in cooperation with the instructions of the CPU 101 according to the control program expanded from the SSD 104 to the RAM 103. The electronic whiteboard 1a further includes a storage unit 1000a, which is implemented by the RAM 103 illustrated in FIG. 3 and the SSD 104 illustrated in FIG. 3.

Functional Units of Electronic Whiteboard 1a:

A description is now given of the functional units of the electronic whiteboard 1a according to embodiments. The data exchange unit 11a exchanges various data (or information) with other terminals, apparatuses, systems, etc. through the communication network 100. Further, the data exchange unit 11a also serves as a start unit and executes a process for starting communication with another communication terminal such as the electronic whiteboard 1b. The acceptance unit 12a accepts various inputs from the user using the electronic pen 190 or the like.

The image/audio processing unit 13a performs main processing of the videoconferencing function. For example, the image/audio processing unit 13a performs digital processing such as encoding of site image data and audio data in accordance with the output signal of the microphone 140 and the output signal of the camera 160. Further, the image/audio processing unit 13a generates an image signal and an audio signal based on the site image data and the audio data received at the data exchange unit 11a. The image/audio processing unit 13a performs processing for combining site image data having different resolutions.

The display control unit 14a performs control for outputting an image signal or the like to the display 180. The determination unit 15a makes various determinations.

The communication capacity measuring unit 16a measures a communication bandwidth of the management information session sei established between the electronic whiteboard 1a and the communication management system 5. The communication capacity measuring unit 16a measures the communication bandwidth of a communication path that has received a band information request in response to the band information request received by the data exchange unit 11a.

The image processing unit 17a performs main processing of the electronic whiteboard function. For example, the image processing unit 17a generates a stroke image and stroke data based on a stroke of the electronic pen 190 or the like accepted by the acceptance unit 12a or generates a stroke image based on stroke data received by the data exchange unit 11a. The image processing unit 17a generates an image signal based on image data of a document image received by the data exchange unit 11a.

The short-range communication unit 18a acquires and provides data through a short-range wireless communication network with each terminal having the short-range communication circuit.

The storing/reading processing unit 19a stores various data in the storage unit 1000a or a storage medium 1010a such as the USB memory 130 and reads various types of data stored in the storage unit 1000a or the storage medium 1010a.

Further, every time site image data and audio data are received in performing communication with other terminal, the storing/reading processing unit 19a overwrites the site image data and audio data stored in the storage unit 1000a. The display 180 displays an image based on site image data before being overwritten, and the speaker 150 outputs sound based on audio data before being overwritten.

Further, stroke data corresponding to a stroke image drawn on the display 180 and document image data corresponding to a document image displayed on the display 180 are stored in the storage unit 1000a.

Functional Configuration of Electronic Whiteboard 1b:

As illustrated in FIG. 6A, the electronic whiteboard 1a includes a data exchange unit 11b, an acceptance unit 12b, an image/audio processing unit 13b, a display control unit 14b, a determination unit 15b, a communication capacity measuring unit 16b, an image processing unit 17b, a short-range communication unit 18b, and a storing/reading processing unit 19b. These units are functions implemented by or caused to function by operating any of the hardware elements illustrated in FIG. 3 in cooperation with the instructions of the CPU 101 according to the control program expanded from the SSD 104 to the RAM 103. The electronic whiteboard 1b further includes a storage unit 1000b, which is implemented by the RAM 103 illustrated in FIG. 3 and the SSD 104 illustrated in FIG. 3. The data exchange unit 11b, the acceptance unit 12b, the image/audio processing unit 13b, the display control unit 14b, the determination unit 15b, the communication capacity measuring unit 16b, the image processing unit 17b, the short-range communication unit 18b, the storing/reading processing unit 19b, and the storage unit 1000b respectively have the same or substantially the same functions as the data exchange unit 11a, the acceptance unit 12a, the image/audio processing unit 13a, the display control unit 14a, the determination unit 15a, the communication capacity measuring unit 16a, the image processing unit 17a, the short-range communication unit 18a, the storing/reading processing unit 19a, and the storage unit 1000a of the electronic whiteboard 1a, and therefore the redundant descriptions thereof are omitted below.

Functional Configuration of Electronic Whiteboard 1c:

As illustrated in FIG. 6B, the electronic whiteboard 1c includes a data exchange unit 11c, an acceptance unit 12c, an image/audio processing unit 13c, a display control unit 14c, a determination unit 15c, a communication capacity measuring unit 16c, an image processing unit 17c, a short-range communication unit 18c, and a storing/reading processing unit 19c. These units are functions implemented by or caused to function by operating any of the hardware elements illustrated in FIG. 3 in cooperation with the instructions of the CPU 101 according to the control program expanded from the SSD 104 to the RAM 103. For example, the CPU 101 of the electronic whiteboard 1c executes a program according to the present disclosure to implement a display control method according to the present disclosure. The electronic whiteboard 1c further includes a storage unit 1000c, which is implemented by the RAM 103 illustrated in FIG. 3 and the SSD 104 illustrated in FIG. 3. The data exchange unit 11c, the acceptance unit 12c, the image/audio processing unit 13c, the display control unit 14c, the determination unit 15c, the communication capacity measuring unit 16c, the image processing unit 17c, the short-range communication unit 18c, the storing/reading processing unit 19c, and the storage unit 1000c respectively have the same or substantially the same functions as the data exchange unit 11a, the acceptance unit 12a, the image/audio processing unit 13a, the display control unit 14a, the determination unit 15a, the communication capacity measuring unit 16a, the image processing unit 17a, the short-range communication unit 18a, the storing/reading processing unit 19a, and the storage unit 1000a of the electronic whiteboard 1a, and therefore the redundant descriptions thereof are omitted below.

Functional Configuration of Relay Device:

As illustrated in FIG. 6B, the relay device 3 includes a data exchange unit 31, which also functions as a transfer unit, a determination unit 35, and a storing/reading processing unit 39. These units are functions implemented by or caused to function by operating any of the hardware elements illustrated in FIG. 4 in cooperation with the instructions of the CPU 501 according to the relay control program expanded from the HD 504 to the RAM 503. Further, the relay device 3 includes a storage unit 3000 implemented by the RAM 503 and the HD 504 illustrated in FIG. 4.

Functional Units of Relay Device:

A description is now given of the functional units of the relay device 3 in detail. The data exchange unit 31 of the relay device 3 illustrated in FIG. 6B exchanges various data (or information) with other terminals, devices, or systems through the communication network 100. The data exchange unit 31 also functions as a transfer unit, and transfers site image data and audio data transmitted from one terminal to another terminal. The determination unit 35 performs various determinations such as determination of whether data transmission is delayed.

The storing/reading processing unit 39 stores various types of data in the storage unit 3000 or reads various types of data stored in the storage unit 3000.

Functional Configuration of Communication Management System:

As illustrated in FIG. 6A, the communication management system 5 includes a data exchange unit 51, an authentication unit 52, a generation unit 53, a selector 54, a determination unit 55, and a storing/reading processing unit 59. These units are functions implemented by or caused to function by operating any of the hardware elements illustrated in FIG. 4 in cooperation with the instructions of the CPU 501 according to the communication control program expanded from the HD 504 to the RAM 503. Further, the communication management system 5 includes a storage unit 5000, which is implemented by HD 504 illustrated in FIG. 4.

Authentication Management Table:

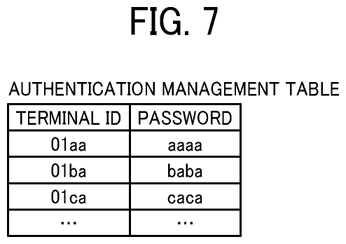

FIG. 7 is an illustration of an example data structure of an authentication management table. The storage unit 5000 stores an authentication management database (DB) 5001, which is implemented by the authentication management table as illustrated in FIG. 7. The authentication management table stores, for each one of the electronic whiteboards 1 managed by the communication management system 5, a terminal ID of the electronic whiteboard and a password in association with each other. For example, the authentication management table illustrated in FIG. 7 indicates that the terminal ID of the electronic whiteboard 1a (communication terminal) is “01aa” and the password of the electronic whiteboard 1a is “aaaa”. The password is an example of authentication information. The authentication information also includes an access token.

Terminal Management Table:

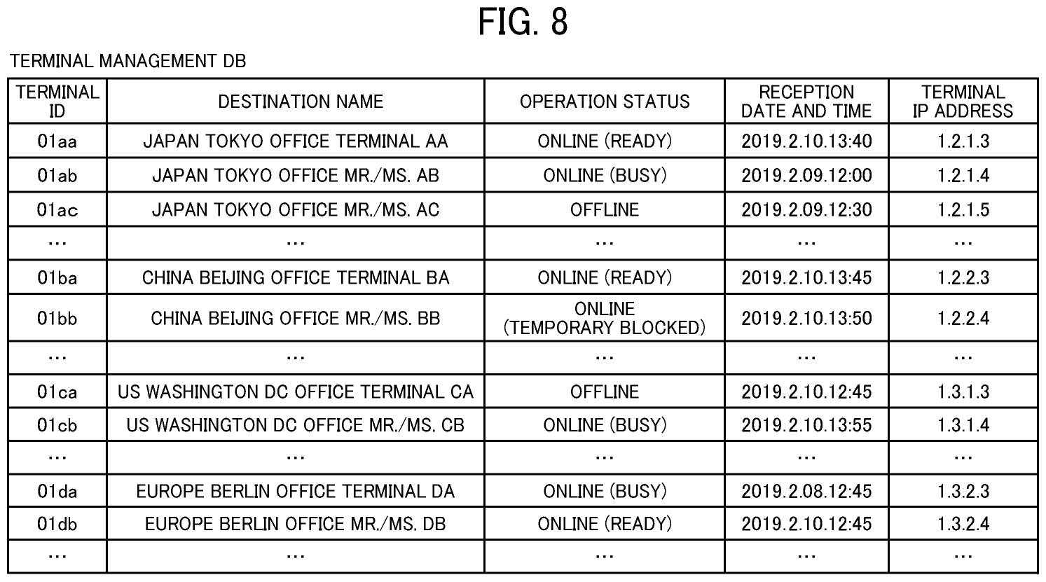

FIG. 8 is an illustration of an example data structure of a terminal management table. The storage unit 5000 stores a terminal management DB 5002, which is implemented by the terminal management table as illustrated in FIG. 8. The terminal management table stores, for each one of the terminal IDs identifying the electronic whiteboards 1 (communication terminals), a terminal name to be used when each electronic whiteboard 1 is a destination terminal, an operating status of each electronic whiteboard 1, reception date and time when login request described below is received by the communication management system 5, and the internet protocol (IP) address of each electronic whiteboard 1 (communication terminal) in association with each other. For example, the terminal management table illustrated in FIG. 8 indicates that the electronic whiteboard 1a whose terminal ID is “01aa” has the terminal name “JAPAN TOKYO OFFICE TERMINAL AA” and the operating status of the electronic whiteboard 1a is “Online (Ready)”. Further, the terminal management table indicates that the date and time when the login request is received by the communication management system 5 is “13:40 on Feb. 10, 2019” and the IP address of the electronic whiteboard 1a is “1.2.1.3”. Note that the terminal ID, the terminal name, and the IP address of the communication terminal are stored when each electronic whiteboard 1 is pre-registered to receive service provided by the communication management system 5.

Destination List Management Table:

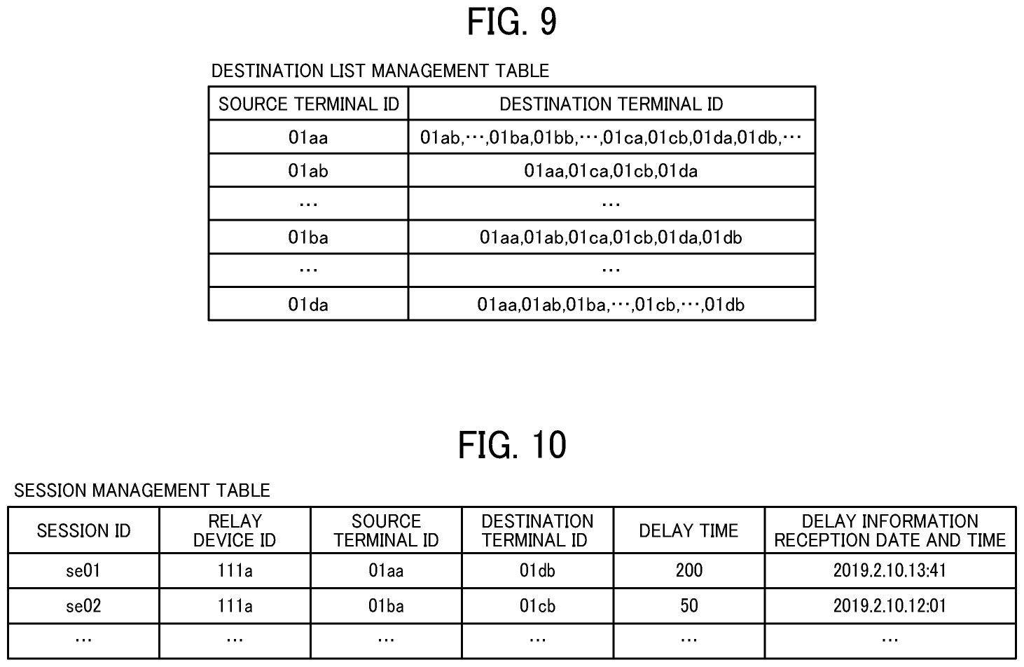

FIG. 9 is an illustration of an example data structure of a destination list management table. The storage unit 5000 stores a destination list management DB 5003, which is implemented by the destination list management table as illustrated in FIG. 9. The destination list management table stores the terminal ID of the source terminal (electronic whiteboard 1) that sends a request for a start of communication in association with the terminal IDs of all destination terminals (electronic whiteboards 1) registered as destination terminal candidates for the source terminal. For example, the destination list management table illustrated in FIG. 9 indicates that the destination terminal candidates to which the source terminal (electronic whiteboard 1a) whose terminal ID is “01aa” can send the request for the start of communication are the electronic whiteboard 1b whose terminal ID is “01ba” and other communication terminal such as the electronic whiteboard whose terminal IDs are “01ab”, “01bb”, etc. The destination terminal candidates are updated by addition or deletion in response to an addition or deletion request transmitted from any source terminal to the communication management system 5.

The destination list is an example of destination information. In another example, the destination information can be managed in various ways other than the list format as illustrated in FIG. 9, as long as information on destination such as a terminal ID can be obtained.

Session Management Table:

FIG. 10 is an illustration of an example data structure of a session management table. The storage unit 5000 stores a session management DB 5004, which is implemented by the session management table as illustrated in FIG. 10. The session management table stores, for each communication session ID for identifying a session to perform mutual communication between each electronic whiteboard 1 (communication terminal) and the relay device 3, a relay device ID of the relay device 3 to be used, a source terminal ID of the electronic whiteboard 1 (source terminal), a destination terminal ID of electronic whiteboard 1 (destination terminal), a delay time (ms) in receiving site image data at the destination terminal, and reception date and time when delay information indicating this delay time is transmitted from the destination terminal and received by the communication management system 5, in association. For example, the session management table illustrated in FIG. 10 indicates that, in a communication session executed using the session ID “se01”, the relay device whose relay device ID is “111a” relays site image data and audio data between the electronic whiteboard whose terminal ID is “01aa” and the electronic whiteboard whose terminal ID “01db”. Further, for example, this session management table indicates that at the electronic whiteboard (destination terminal), the delay time of the site image data at “13:41 on Feb. 10, 2019” is 200 ms.

Relay Device Management Table:

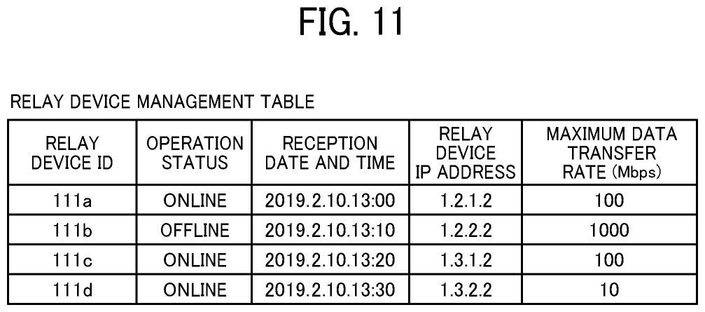

FIG. 11 is an illustration of an example data structure of a relay device management table. The storage unit 5000 stores a relay device management DB 5005, which is implemented by the relay device management table as illustrated in FIG. 11. The relay device management table stores, for each one of the relay devices 3, the relay device ID, the operation status of the relay device 3, the date and time when the communication management system 5 received status information indicating the operation status, an IP address of the relay device 3, and maximum data transfer rate (Mbps) of the relay device 3, in association. For example, the relay device management table illustrated in FIG. 11 indicates that the relay device 3 whose relay device ID is “111a” has the operation status “Online”, the date and time when the communication management system 5 received the operation status is “13:30 on Feb. 10, 2019”, the IP address of the relay device 3 is “1.2.1.2”, and the maximum data transfer rate of the relay device 3 is 100 Mbps.

Stroke Data Management Table:

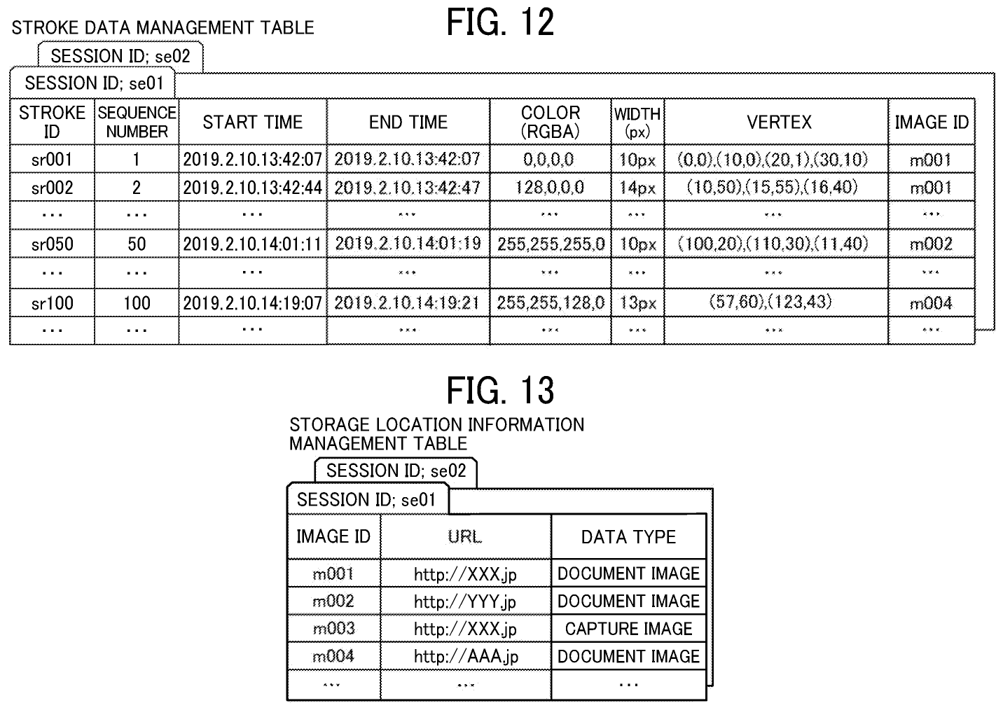

FIG. 12 is an illustration of an example data structure of a stroke data management table. The storage unit 5000 stores a stroke data management DB 5006, which is implemented by the stroke data management table as illustrated in FIG. 12. The stroke data management table stores, for each session ID identifying a session to perform mutual communication between each electronic whiteboard 1 (communication terminal) and the relay device 3, the session ID and stroke data in association with each other. The stroke data includes information of a stroke ID, a sequence number, a start time, an end time, a color of a drawn stroke, a width indicating a line width of the drawn stroke, vertices of the drawn stroke, and an image ID. The stroke ID identifies stroke data generated by a stroke drawing event. The sequence number indicates the order in which the stroke drawing events occur. The start time indicates the time when drawing of the stroke starts. The end time indicates the time when drawing of the stroke ends. The image ID identifies a document image, which is a background image on which the stroke is drawn.

In the embodiments, the “stroke drawing” is an input process of drawing data by a user. For example, the stroke drawing is an event detected from when a user presses the electronic pen 190 against the display 180 and moves the electronic pen 190 with the electronic pen in contact with the surface of the display 180 until when the user releases the electronic pen 190 from the display 180. The color of the stroke is represented in a data format of RGBA (Red Green Blue Alpha), and each element is represented by a numerical value of 0 to 255. Further, the width of the line of the drawn stroke is represented by the number of pixels. The vertices of the drawn stroke are represented by X-Y coordinates. A Bezier curve obtained from the vertices forms a line segment indicating the stroke. Using this stroke data management table, the communication management system 5 manages stroke data generated during a videoconference or the like conducted through a particular communication session.

Storage Location Information Management Table:

FIG. 13 is an illustration of an example data structure of a storage location information management table. The storage unit 5000 stores a storage location information management DB 5007, which is implemented by the storage location information management table as illustrated in FIG. 13. The storage location information management table stores, for each communication session ID identifying a session to perform mutual communication between each electronic whiteboard 1 and the relay device 3, an image ID identifying image data, a uniform resource locator (URL) indicating a storage location where the image data is stored, and information on data type of the image data to be stored in the URL in association.

The URL is an example of storage location information. In another example, the storage location information includes a uniform resource identifier (URI). Examples of the data type include a document image and a capture image. The document image is an image displayed on the display 180 of the electronic whiteboard 1, and also is a background image on which a stroke image is to be superimposed. The capture image is an image obtained by capturing a display screen displayed on the display 180 of the electronic whiteboard 1. Using the storage location information management table, the communication management system 5 manages image data such as data of a document image or the like generated curing the videoconference or the like conducted through a particular communication session.

Functional Units of Communication Management System:

Referring again to FIG. 6A, the data exchange unit 51 of the communication management system 5 transmits and receives various data (or information) to and from other terminals, devices, or systems through the communication network 100. For example, the data exchange unit 51 transmits a capture image data generation request indicating a request for generation of capture image data to the electronic whiteboard 1 that is performing a remote conference.

The authentication unit 52 searches the authentication management DB 5001 stored in the storage unit 5000 using the terminal ID and password included in a login request received through the data exchange unit 51 as search keys, to perform authentication by determining whether the same pair of a terminal ID and a password are stored in the authentication management DB 5001. The generation unit 53 generates a session ID for identifying a communication session based on a communication start request from the electronic whiteboard 1 (described below as step S32). The selector 54 performs a process of selecting one relay device 3 from the plurality of relay devices 3. The determination unit 55 performs various determinations. The storing/reading processing unit 59 stores various types of data in the storage unit 5000 or reads various types of data stored in the storage unit 5000.

Functional Configuration of Image Storage Device:

As illustrated in FIG. 6B, the image storage device 7 includes a data exchange unit 71 and a storing/reading processing unit 79. These units are functions implemented by or caused to function by operating any of the hardware elements illustrated in FIG. 4 in cooperation with the instructions of the CPU 501 according to the image storage control program expanded from the HD 504 to the RAM 503. Further, the image storage device 7 includes a storage unit 7000, which is implemented by the RAM 503 and the HD 504 illustrated in FIG. 4. The storage unit 7000 stores document image data or capture image data at a storage location indicated by the URL generated by the communication management system 5.

Functional Units of Image Storage Device:

A description is now given of the functional units of the image storage device 7 in detail. The data exchange unit 71 of the image storage device 7 illustrated in FIG. 6B transmits and receives various data (or information) to and from other terminals, devices, or systems through the communication network 100. The storing/reading processing unit 79 stores various types of data in the storage unit 7000 or reads various types of data stored in the storage unit 7000.

Operation:

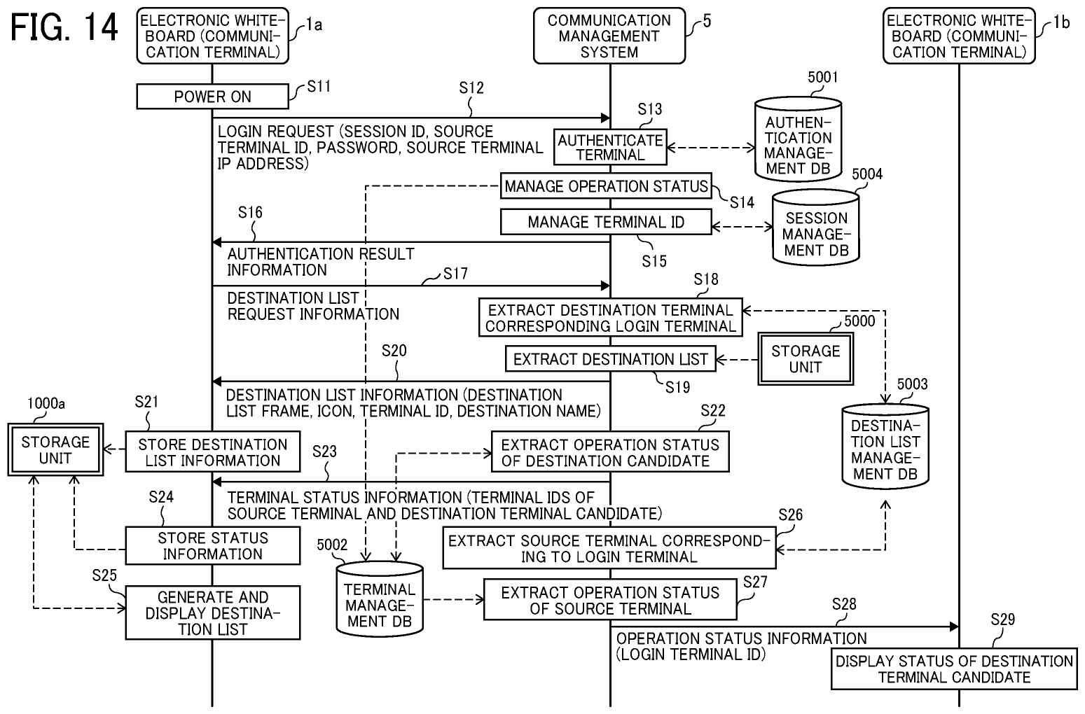

A description is now given of operations performed by the communication system according to embodiments of the present disclosure, with reference to FIG. 14 to FIG. 25.

Operation of Preparing for Remote Communication:

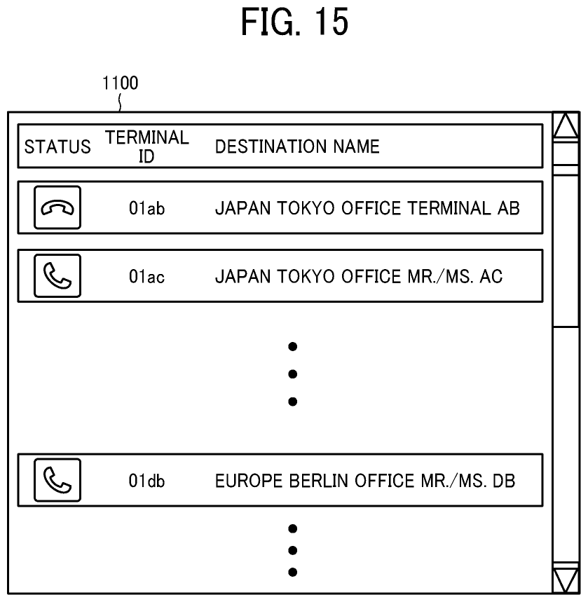

First, a description is given of operation of preparing for remote communication, performed by the electronic whiteboard 1a as a login request sender terminal, with reference to FIG. 14 and FIG. 15. FIG. 14 is a sequence diagram illustrating operation for preparing to start remote communication between the electronic whiteboards. FIG. 15 is a diagram illustrating an example of a destination list displayed on the electronic whiteboard 1a. The electronic whiteboard 1b performs login operation in the same or substantially the same manner as the electronic whiteboard 1a, and thus the redundant description thereof is omitted below.

In step S11, when the power switch 122 of the electronic whiteboard 1a is turned on, the acceptance unit 12a accepts a request to turn on the power of the electronic whiteboard 1a.

In step S12, the data exchange unit 11a transmits login request information indicating a request for login authentication to the communication management system 5 through the communication network 100. This login request information includes the terminal ID and password of the electronic whiteboard 1a.

In step S13, the authentication unit 52 of the communication management system 5 searches the authentication management table (FIG. 7) using the terminal ID and the password included in the login request information received through the data exchange unit 51 as search keys, to authenticate the communication terminal (electronic whiteboard 1) by determining whether the same terminal ID and the same password are stored in the authentication management table. In the embodiment, the description is continued assuming that the same terminal ID and the same password are stored in the authentication management table.

When the same terminal ID and the same password are stored in the authentication management table, the authentication unit 52 determines that the login request is received from the communication terminal (electronic whiteboard) that has a usage authorization. Accordingly, in step S14, the storing/reading processing unit 59 of the communication management system 5 updates the operation status associated with the terminal ID received in step S12 in the terminal management table (FIG. 8) “Online (Ready)”. Further, the storing/reading processing unit 59 stores the reception date and time when the login request information is received in step S12 in the reception date and time field in the terminal management table. As a result, in the terminal management table, the terminal ID “01aa”, the operation status “Online (Ready)”, the reception date and time “2019.2.10.13:40”, and the IP address “1.2.1.3” are stored in association with each other. In another example, the IP address of the communication terminal (electronic whiteboard) may not be registered is transmitted from the electronic whiteboard 1a in step S12, instead of being stored in advance.

In step S15, the storing/reading processing unit 59 adds a new record including the terminal ID of the electronic whiteboard 1a received in step S12 in the session management table as illustrated in FIG. 10. In step S16, the data exchange unit 51 of the communication management system 5 transmits the authentication result obtained in step S13 to the electronic whiteboard 1a that has sent the login request through the communication network 100.

In step S17, when the data exchange unit 11a of the login request sender terminal (electronic whiteboard 1a) receives the authentication result indicating that the communication terminal (electronic whiteboard 1a) has a usage authorization, the data exchange unit 11a transmits destination list request information indicating a request for a destination list to the communication management system 5 through the communication network 100. Accordingly, the data exchange unit 51 of the communication management system 5 receives the destination list request information.

In step S18, the storing/reading processing unit 59 searches the destination list management table (FIG. 9) using the terminal ID “01aa” of the login request sender terminal (electronic whiteboard 1a) as a search key, to read the terminal IDs of the destination terminal candidates that can communicate with the login request sender terminal (electronic whiteboard 1a). Further, the storing/reading processing unit 59 reads the destination names associated with the terminal IDs from the terminal management table (FIG. 8). As a result, the terminal ID and terminal name of each of the destination terminal candidates corresponding to the terminal ID “01aa” of the login request sender terminal (electronic whiteboard 1a) are extracted.

In step S19, the data exchange unit 51 of the communication management system 5 reads destination list frame data and icon data indicating the operation status from the storage unit 5000 through the storing/reading processing unit 59. In step S20, the data exchange unit 51 of the communication management system 5 transmits destination list information including the destination list frame, the icon, the terminal IDs, and the terminal names that are read by the storing/reading processing unit 59 to the login request sender terminal (electronic whiteboard 1a). Accordingly, the data exchange unit 11a of the login request sender terminal (electronic whiteboard 1a) receives the destination list information. In step S21, the storing/reading processing unit 19a stores the destination list information in the storage unit 1000a.

As described above, in the present embodiment, the communication management system 5 centrally manages the destination list information of all terminals, instead of that each terminal manages the destination list information. For example, when a new electronic whiteboard 1 is added to the communication system, when a terminal already included in the communication system is replaced with a new model, or when appearance of the destination list frame is to be changed, since the communication management system 5 according to the present embodiment centrally manages all destination candidates, time and efforts for change the destination list information on each terminal are saved.

In step S22, the storing/reading processing unit 59 of the communication management system 5 searches the terminal management table (FIG. 8) using the read-out terminal IDs of the destination terminal candidates as search keys, to read the operation statuses associated with the terminal IDs, thereby acquiring the operation status of each of the electronic whiteboards 1 as the destination terminal candidates.

In step S23, the data exchange unit 51 transmits terminal status information including the terminal IDs that are used as the search keys in step S22 and the operation statuses of the corresponding destination terminals through the communication network 100 to the login request sender terminal (electronic whiteboard 1a).

In step S24, the storing/reading processing unit 19a of the login request sender terminal (electronic whiteboard 1a) successively stores the operation status information of the terminals received from the communication management system 5 in the storage unit 1000a. As a result, the login request sender terminal (electronic whiteboard 1a) acquires the operation status of the destination terminal candidate (electronic whiteboard 1b) that can communicate with the login request sender terminal (electronic whiteboard 1a).

In step S25, the display control unit 14a of the login request sender terminal (electronic whiteboard 1a) generates a destination list reflecting the operation statuses of the destination terminal candidates based on the destination list information and the operation status information stored in the storage unit 1000a. Further, the display control unit 14a controls the display 180 of the electronic whiteboard 1a to a destination list screen 1100 as illustrated in FIG. 15. On the destination list screen 1100, the icon indicating the operation status, the terminal ID, and the terminal name are displayed for each destination terminal candidate. In the example of FIG. 15, the icons representing the operation statuses of the communication terminals displayed from the top of the screen indicate the operation status “Offline”, “Online (Ready)”, and “Online (Ready)”.

In step S26, the storing/reading processing unit 59 of the communication management system 5 searches the destination list management table (FIG. 9) based on the terminal ID “01aa” of the login request sender terminal (electronic whiteboard 1a), to extract the terminal IDs of other communication terminals that have registered the terminal ID “01aa” of the login request sender terminal (electronic whiteboard 1a) as the destination terminal candidate. In the destination list management table illustrated in FIG. 9, the terminal IDs of other terminals to be read in step S26 are “01ab”, “01ba”, and “01da”.

In step S27, the storing/reading processing unit 59 of the communication management system 5 searches the terminal management table (FIG. 8) based on the terminal ID “01aa” of the login request sender terminal (electronic whiteboard 1a), to acquire the operation status of the login request terminal (electronic whiteboard 1a).

In step S28, the data exchange unit 51 transmits the terminal status information including the terminal ID “01aa” of the login request sender terminal (electronic whiteboard 1a) and the terminal status information including the operation status “Online” acquired in step S27, to the communication terminal(s) whose operation status is “Online” in the terminal management table (FIG. 8) among the communication terminals identified by the terminal IDs extracted in step S26. When the data exchange unit 51 transmits the terminal status information to the electronic whiteboard 1b, the IP address of the electronic whiteboard stored in the terminal management table (FIG. 8) is referred to based on each terminal ID. Thus, the terminal ID “01aa” and the operation status “Online” of the login request sender terminal (electronic whiteboard 1a) are transmitted to each of the other destination terminals that can communicate with the login request sender terminal (electronic whiteboard 1a) as a destination terminal candidate. Accordingly, in step S29, the operation status of the other destination terminal candidate is displayed on the destination terminal candidate (such as the electronic whiteboard 1b).

Operation of Starting Remote Communication:

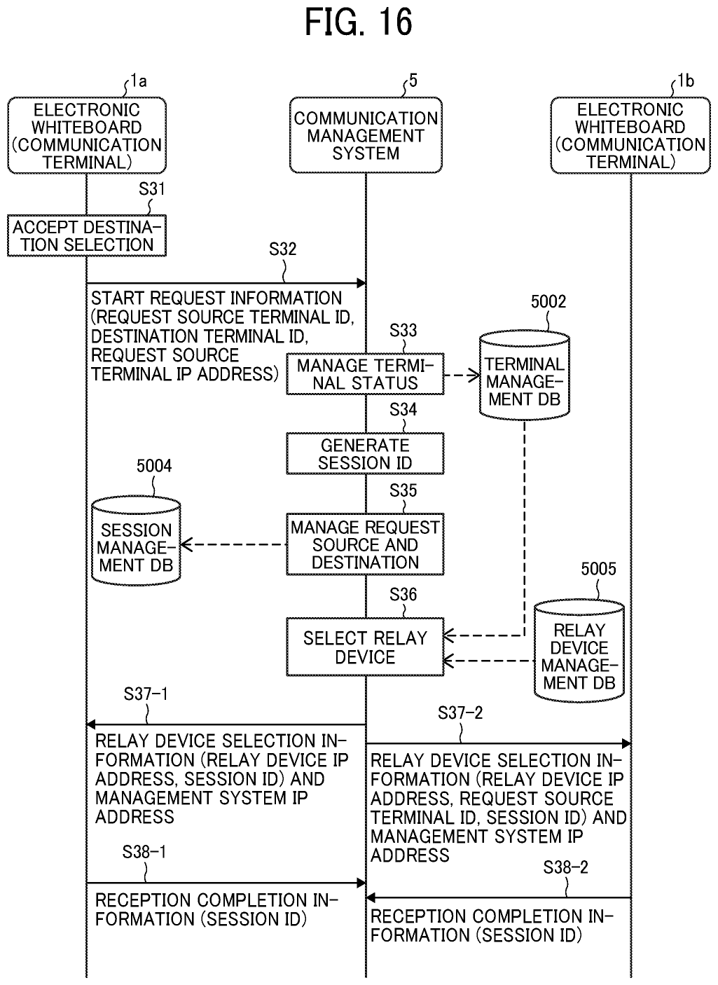

A description is now given of operation in which the electronic whiteboard 1a starts remote communication with the electronic whiteboard 1b, with reference to FIG. 16. FIG. 16 is a sequence diagram illustrating operation of starting remote communication.

In step S31, when the user A1 of a request source terminal (electronic whiteboard 1a) selects the electronic whiteboard 1b by selecting a destination terminal candidate (terminal ID “01ba”) illustrated in FIG. 15, the acceptance unit 12a illustrated in FIG. 6A accepts a request to start communication with the selected destination terminal (electronic whiteboard 1b). In step 32, the data exchange unit 11a of the request source terminal (electronic whiteboard 1a) transmits start request information indicating a request for starting communication to the communication management system 5. The start request information includes the terminal ID “01aa” of the request source terminal (electronic whiteboard 1a) and the terminal ID “01ba” of the destination terminal (electronic whiteboard 1b). Accordingly, the data exchange unit 51 of the communication management system 5 receives the start request information and the IP address of the request source terminal (electronic whiteboard 1a) from which the start request information is transmitted.

In step S33, the storing/reading processing unit 59 changes the operation status in each of records including the terminal ID “01aa” and the terminal ID “01ba” to “busy” in the terminal management table (FIG. 8) based on the terminal ID “01aa” of the request source terminal (electronic whiteboard 1a) and the terminal ID “01ba” of the destination terminal (electronic whiteboard 1b) included in the start request information. In this state, the request source terminal (electronic whiteboard 1a) and the destination terminal (electronic whiteboard 1b) have not started a videoconference but are in a call status. In this case, when a third electronic whiteboard (e.g., electronic whiteboard 1c) tries to make a call with the request source terminal (electronic whiteboard 1a) or the destination terminal (electronic whiteboard 1b), a notification sound or display indicating a busy status is output.

Next, a description is given of operation of executing a session for selecting the relay device 3 to be used. In step S34, the generation unit 53 of the communication management system 5 generates session ID used for execution of the session for selecting the relay device 3. In the embodiment, a description is given of an example case in which the session ID “se01” is generated.

In step S35, the storing/reading processing unit 59 stores the session ID “se01” generated in step S34, the terminal ID “01aa” of the request source terminal (electronic whiteboard 1a), and the terminal ID “01ba” of the destination terminal (electronic whiteboard 1b) in association with each other in the session management table (FIG. 10).

In step S36, the selector 54 of the communication management system 5 illustrated in FIG. 6A selects the relay device 3 for relaying a call between the two sites where the request source terminal (electronic whiteboard 1a) and the destination terminal (electronic whiteboard lb) are located, based on the relay device management table (FIG. 11) and the terminal management table illustrated (FIG. 8). Specifically, the selector 54 selects, among the relay device IDs corresponding to the relay devices whose operation statuses are “ONLINE” in the relay device management table (FIG. 11), the relay device ID corresponding to the relay device 3 whose IP address is close to the IP address of the request source terminal (electronic whiteboard 1a) in the terminal management table (FIG. 8). In the embodiment, the following description is given of an example case where the relay device 3 identified by the relay device ID “111a” is selected.

In step S37-1, when the relay device selection process in step S36 is completed, the data exchange unit 51 of the communication management system 5 transmits relay device selection information to the request source terminal (electronic whiteboard 1a). The relay device selection information includes the IP address of the relay device 3 selected in step S36 and the session ID “se01” generated in step S34. Thereby, the request source terminal (electronic whiteboard 1a) acquires the IP address of the communication management system 5, which is the transmission source of the relay device selection information.

In step S37-2, the data exchange unit 51 of the communication management system 5 transmits the relay device selection information to the destination terminal (electronic whiteboard 1b). The relay device selection information includes the IP address of the relay device 3 selected in step S36, the terminal ID “01aa” of the request source terminal (electronic whiteboard 1a), and the session ID “se01” generated in step S34. Thereby, the destination terminal (electronic whiteboard 1b) acquires the IP address of the communication management system 5, which is the transmission source of the relay device selection information, in execution of a session with the session ID “se01”.

In step S38-1, in response to the process of S37-1, the data exchange unit 11a of the request source terminal (electronic whiteboard 1a) transmits reception completion information indicating that the relay device selection information is received in step S37-1 to the communication management system 5. The reception completion information includes the session ID exchanged in the process of step S37-1. Thereby, the communication management system 5 acknowledges that the transmission of the relay device selection information, executed with the specific session ID “se01” has been completed.

In step 38-2, in response to the process of step S37-2, the destination terminal (electronic whiteboard 1b) also transmits the reception completion information indicating that the relay device selection information has been received through the process of step S37-2 to the communication management system 5. The communication management system 5 acknowledges that the transmission of the relay device selection information, executed with the specific session ID “se01”, has been completed.

Thus, the electronic whiteboard 1a and the electronic whiteboard 1b perform a videoconference by exchanging site image data and audio data through the relay device 3 selected in step S36.

Operation of Communicating Document Image and Stroke Image:

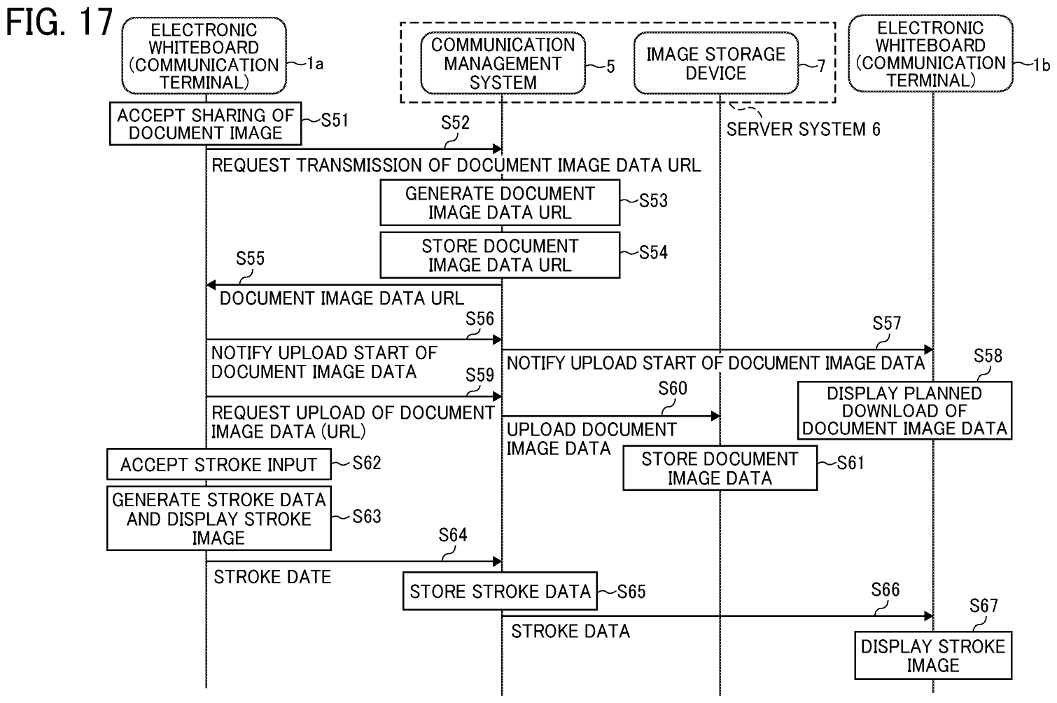

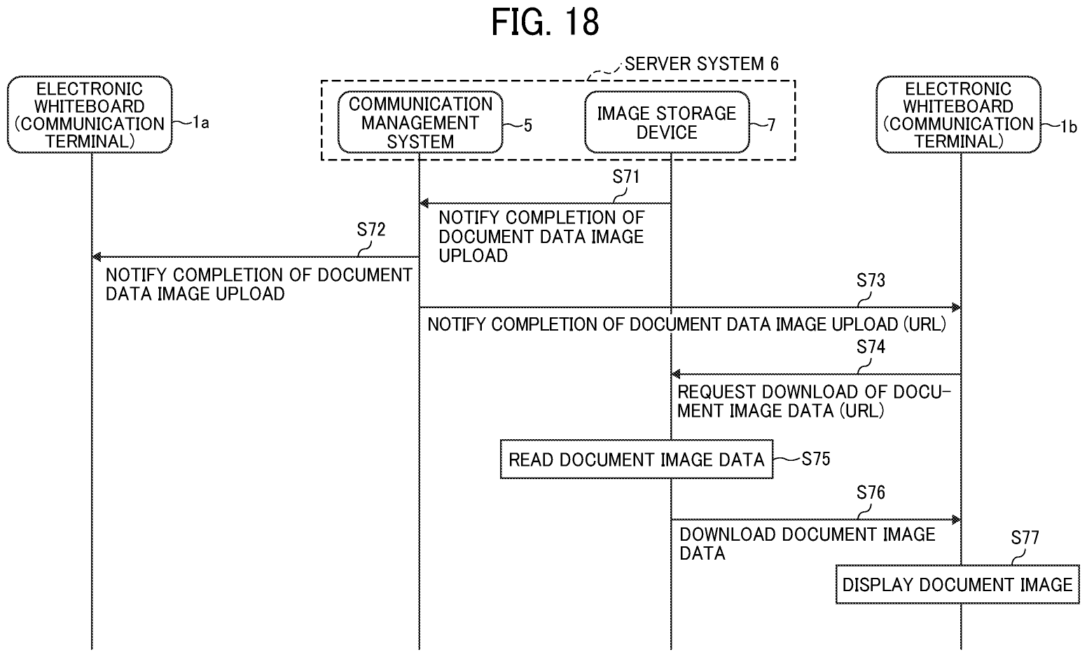

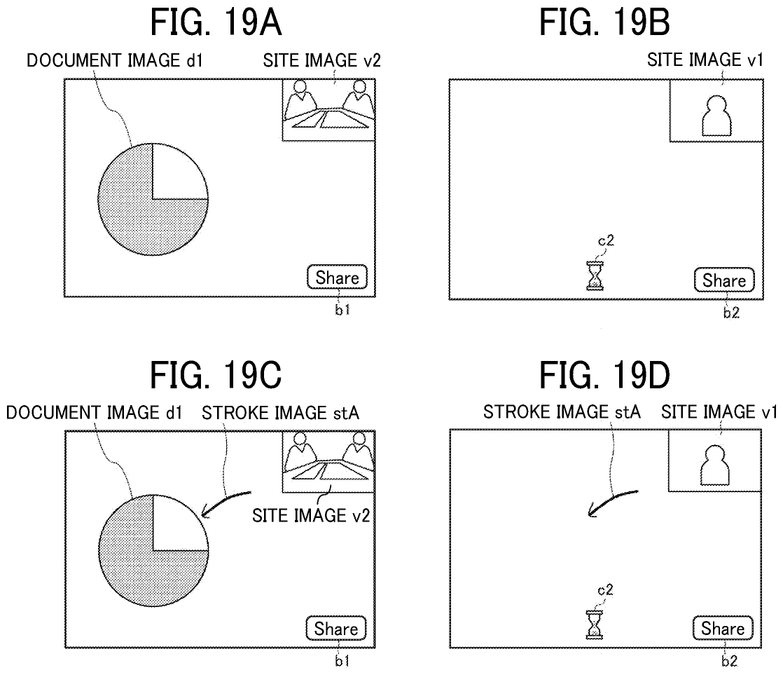

A description is now given of operation of communicating a document image displayed on the electronic whiteboard 1 and a stroke image input to the electronic whiteboard 1, with reference to FIG. 17 to FIG. 19D. FIG. 17 and FIG. 18 are sequence diagrams illustrating operation for sharing document image data and stroke data. In the present embodiment, the electronic whiteboard 1a and the electronic whiteboard 1b share data, such as the document image data and the stroke data. Here, a case where the document image and the stroke image displayed on the electronic whiteboard 1a are also displayed on the electronic whiteboard 1b is described. FIG.19A is a screen example of the electronic whiteboard 1a. FIG. 19B is a screen example of the electronic whiteboard 1b. FIG. 19C is another screen example of the electronic whiteboard 1a. FIG. 19D is another screen example of the electronic whiteboard 1b.

On the electronic whiteboard 1a at the site A, the screen illustrated in FIG. 19A is displayed on the display 180 by the display control unit 14a. A document image d1, a site image v2 of the site B, and a Share button b1 to be pressed when sharing the document image d1 are displayed on the electronic whiteboard 1a at the site A. In step S51, the acceptance unit 12a accepts an instruction to share data, such as the document image, in response to a pressing of the Share button b1 by the user A1 of the electronic whiteboard 1a. In step S52, the data exchange unit 11a transmits request information indicating a request for a URL indicating the storage location of document image data, which is image data of the document image, to the communication management system 5. Thereby, the data exchange unit 51 of the communication management system 5 receives the request information. The URL is an example of storage location information. In another example, the storage location information includes a URI.

In step S53, the generation unit 53 of the communication management system 5 generates a URL indicating the storage location of the document image data. In step S54, the storing/reading processing unit 59 stores the URL generated by the generation unit 53 in the storage location information management DB 5007 (FIG. 13). Specifically, the storing/reading processing unit 59 stores, in the storage location information management table, the URL generated by the generation unit 53 in association with an image ID (e.g., “m001”), which is newly assigned, and a data type “document image”. In step S55, the data exchange unit 51 transmits the URL indicating the storage location of the document image data generated by the generation unit 53 to the electronic whiteboard 1a. Thereby, the data exchange unit 11a of the electronic whiteboard 1a receives the URL indicating the storage location of the document image data.

In step S56, the data exchange unit 11a of the electronic whiteboard 1a transmits an upload start notice of the document image data to the communication management system 5. Thereby, the data exchange unit 51 of the communication management system 5 receives the upload start notice.

In step S57, the data exchange unit 51 transfers the upload start notice to the electronic whiteboard 1b participating in the remote conference. Thereby, the data exchange unit 11b of the electronic whiteboard 1b receives the upload start notice. In step S58, the display control unit 14b of the electronic whiteboard 1b controls the display 180 of the electronic whiteboard 1 to display a screen as illustrated in FIG. 19B. Specifically, in response to receiving the upload start notice in step S57, the display control unit 14b of the electronic whiteboard 1b displays an hourglass icon c2 that visually indicates the progress in downloading the document image data, in addition to a site image v1 of the site A and a Share button b2, which are displayed in advance.

In this example, elapsed time, which reflects the progress, can be indicated by a still-image hourglass or an animated hourglass with the change in amount of sand in the hourglass. The hourglass icon c2 is an example of progress information indicating that downloading of the document image data is taking place. Other examples of progress information may be any icon other than hourglass icon, for example, a clock icon, character (and/or symbol) instead of icon, or combination of icon and character (and/or symbol). The progress information may be output as a notification by sound. In this case, instead of the display control unit 14a, the image/audio processing unit 13a controls the speaker 150 to output the sound.

The electronic whiteboard 1a may perform the process of step S52 after the process of step S56. The communication management system 5 may transmit the URL indicating the storage location of the document image data in step S55 after receiving the upload start notice of the document image data in step S56.

In step S59, the data exchange unit 11a of the electronic whiteboard 1a transmits an upload request of the document image data to the communication management system 5. This upload request includes the document image data and the URL indicating the storage location of the document image data received in step S55. Thereby, the data exchange unit 51 of the communication management system 5 receives the upload request from the electronic whiteboard 1a. In step S60, the data exchange unit 51 of the communication management system 5 uploads the document image data to a storage location of the image storage device 7 indicated by the URL received in step S59. Thereby, the data exchange unit 71 of the image storage device 7 receives the document image data. In step S61, the storing/reading processing unit 79 of the image storage device 7 stores the document image data in the storage location indicated by the URL in the storage unit 7000. In another example, the electronic whiteboard 1a may upload the document image data directly to the storage location indicated by the URL at the image storage device 7 not through the communication management system 5.

In step S62, at the site A, the user A1 moves the electronic pen 190 or the hand H in contact with the display 180 of the electronic whiteboard 1a, and the acceptance unit 12a accepts an input of a stroke movement (trajectory). In step S63, the image processing unit 17a creates stroke data (for example, coordinate data (x, y)) for displaying a stroke image on the two-dimensional display 180 based on the stroke. The display control unit 14a controls the display 180 of the electronic whiteboard 1a to display the stroke image based on the stroke data. Thereby, a stroke image stA is displayed as illustrated in FIG. 19C.

In step S64, the data exchange unit 11a transmits the stroke data generated in step S63 for reproducing the stroke image to the communication management system 5. Thereby, the data exchange unit 51 of the communication management system 5 receives the stroke data of the stroke image. In step S65, the storing/reading processing unit 59 of the communication management system 5 stores the stroke data received in step S64 in the stroke data management DB 5006 (FIG. 12). Specifically, as illustrated in FIG. 12, the storing/reading processing unit 59 stores, in the stroke data management table, items of the stroke data received by the data exchange unit 51 in the order of occurrence (sequence order) in association with the session ID of the communication session with which the remote conference is conducted.

In step S66, the data exchange unit 51 transfers the stroke data to the electronic whiteboard 1b, which is the counterpart terminal. Thereby, the data exchange unit 11b of the electronic whiteboard 1b receives the stroke data. In step S67, the image processing unit 17b of the electronic whiteboard 1b generates a stroke image based on the stroke data, and the display control unit 14b controls the display 180 of the electronic whiteboard 1b to display the stroke image. Thereby, the same stroke image stA as that of displayed on the electronic whiteboard 1a as the counterpart terminal is displayed, as illustrated in FIG. 19D.

Now referring to FIG. 18, in step S71, the data exchange unit 71 of the image storage device 7 transmits an upload completion notice indicating that the upload of the document image data is completed to the communication management system 5. Thereby, the data exchange unit 51 of the communication management system 5 receives the upload completion notice. In step S72, the data exchange unit 51 of the communication management system 5 transfers the upload completion notice indicating that the document image data is completed to the electronic whiteboard 1a. Thereby, the data exchange unit 11a of the electronic whiteboard 1a receives the upload completion notice. In another example, the image storage device 7 may transmit the upload completion notice directly to the electronic whiteboard la not through the communication management system 5. In this case, in response to receiving the upload completion notice from the image storage device 7, the electronic whiteboard la transmits, to the communication management system 5, the upload completion notice including the URL indicating the storage location of the document image data received in step S55.

In step S73, the data exchange unit 51 of the communication management system 5 transmits the upload completion notice including the URL indicating the storage location of the document image data to the electronic whiteboard 1b as the counter terminal. Thereby, the data exchange unit 11b of the electronic whiteboard 1b receives the upload completion notice.

In step S74, the data exchange unit 11b of the electronic whiteboard 1b transmits download request information indicating a request for downloading the document image data by accessing the URL indicating a storage location at the image storage device 7 received in step S73. Thereby, the data exchange unit 71 of the image storage device 7 receives the download request information.

In step S75, the storing/reading processing unit 79 of the image storage device 7 reads the document image data, which is a request target, from the storage unit 7000 based on the URL. In step S76, the data exchange unit 71 transmits the requested document image data to the electronic whiteboard 1b as the request source terminal. Thereby, the data exchange unit 11b of the electronic whiteboard 1b downloads (receives) the document image data. In step S77, the display control unit 14b of the electronic whiteboard 1b displays the same document image as the document image d1 illustrated in FIG. 19C on the screen illustrated in FIG. 19D and stops displaying the hourglass icon c2 displayed until then.

Operation of Communicating Document Image and Stroke Image to Halfway Participating Terminal:

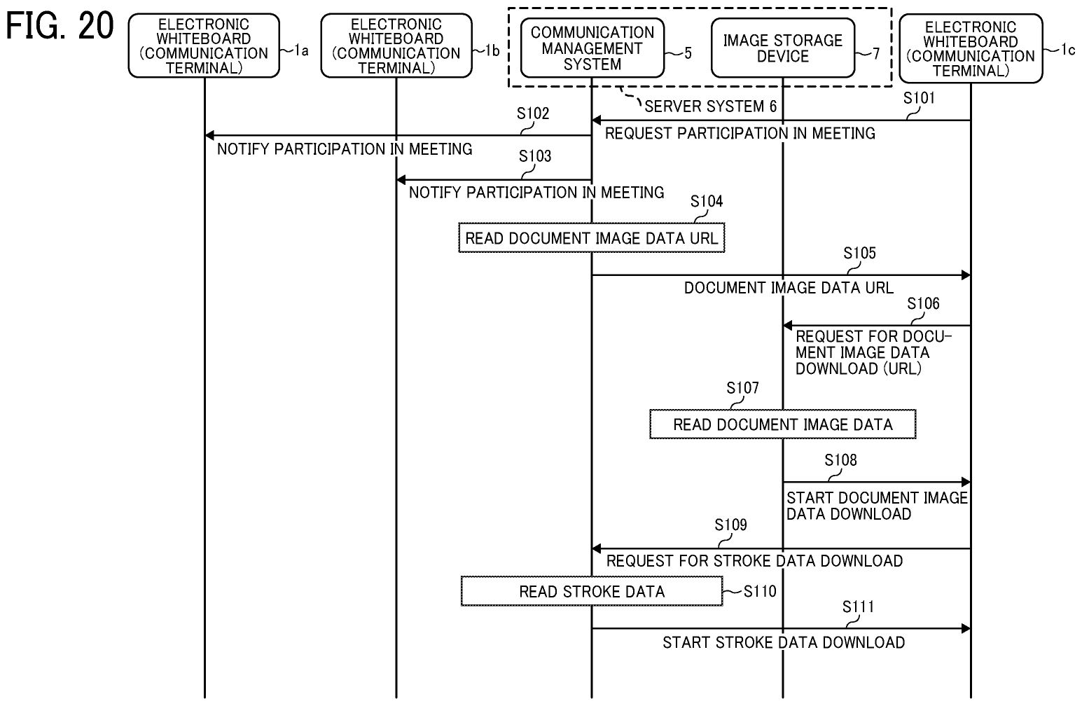

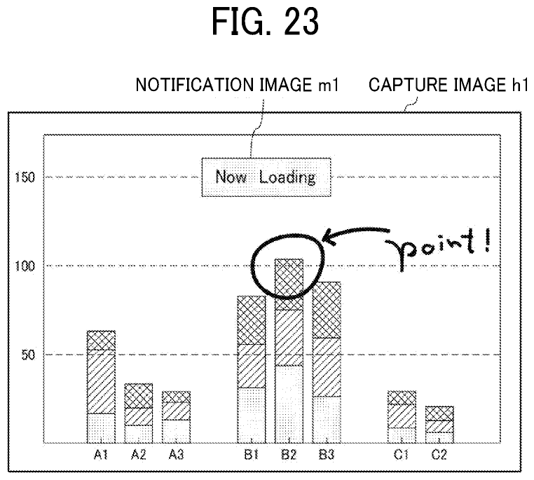

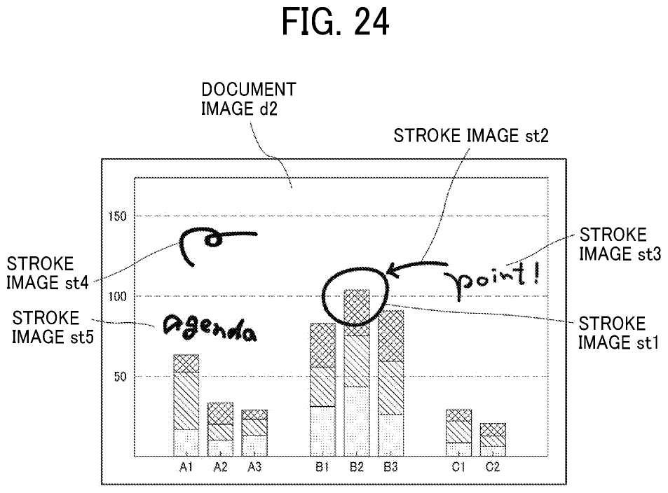

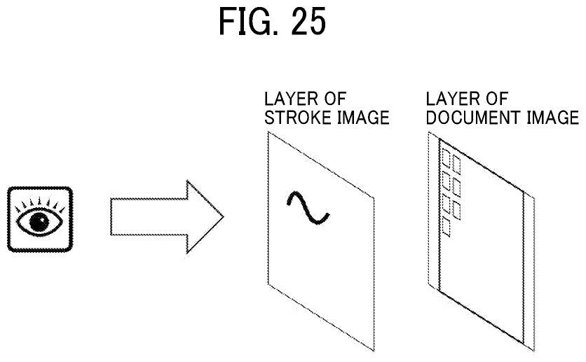

A description is now given of an example in which another electronic whiteboard 1 provided at another site joins part way through a remote conference (videoconference) that is already started among the plurality of electronic whiteboards 1 provided at plural sites, with reference to FIG. 20 to FIG. 25. FIG. 20 to FIG. 22 are sequence diagrams illustrating operation of sharing document image data and stroke data with a communication terminal that joins part way through an on-going remote conference or the like. FIG. 23 is a diagram illustrating an example of a screen in which a capture image is displayed on the electronic whiteboard 1c. FIG. 24 is a diagram illustrating an example of a screen in which a document image and a stroke image are displayed on the electronic whiteboard 1c. FIG. 25 is a diagram illustrating an example how plural images are superimposed in a display image displayed on the electronic whiteboard 1. In the following, an example is described in which the electronic whiteboard 1c joins part way through a remote conference (videoconference) that is already conducted between the electronic whiteboard 1a and the electronic whiteboard 1b. Any electronic whiteboard 1 that joins part way through an already-started remote conference (videoconference) may be referred to as a “halfway participating terminal” hereinafter. In the following example, the electronic whiteboard 1c is the halfway participating terminal. The timing when the halfway participating terminal joins the remote conference can be any time after the remote conference begins.

In step S101, the data exchange unit 11c of the electronic whiteboard 1c, which is to join part way through an already-started remote conference (videoconference) between the electronic whiteboard 1a and the electronic whiteboard 1b transmits a conference participation request to the communication management system 5. The following description is given on the assumption that at the electronic whiteboard 1c, a communication session whose session ID “se01” is established by the operation described above with reference to FIG. 14 and FIG. 16.

In step S102, the data exchange unit 51 of the communication management system 5 transmits a conference participation notice indicating that the electronic whiteboard 1c has participated in the remote conference, to the electronic whiteboard 1a that is conducting the remote conference using the communication session whose session ID “se01”. Thereby, the data exchange unit 11a of the electronic whiteboard 1a receives the conference participation notice from the communication management system 5. In step S103, the data exchange unit 51 of transmits the conference participation notice also to the electronic whiteboard 1b. Thereby, the data exchange unit 11a of the electronic whiteboard 1b receives the conference participation notice from the communication management system 5. Thus, the user A1 of the electronic whiteboard 1a and the users B1 and B2 of the electronic whiteboard 1b recognizes that the electronic whiteboard 1c has participated in the remote conference.

In S104, the storing/reading processing unit 59 of the communication management system 5 searches the storage location information management table (FIG. 13) using the session ID as a search key, to read a URL indicating a storage location where document image data generated during the remote conference is stored. In this example, the storing/reading processing unit 59 reads out the URLs corresponding to the image IDs “m001”, “m002”, and “m004” identifying the document images associated with the session ID “se01”.

In step S105, the data exchange unit 51 of the communication management system 5 transmits the URLs indicating the storage location of the document image data read in step S104 to the halfway participating terminal (electronic whiteboard 1c). Thereby, the data exchange unit 11c of the electronic whiteboard 1a receives the URLs indicating the storage locations of the document image data.

In step S106, the data exchange unit 11c of the halfway participating terminal (electronic whiteboard 1c) transmits download request information indicating a request for downloading document image data by accessing the URLs indicating storage locations at the image storage device 7 received in step S105. Thereby, the data exchange unit 71 of the image storage device 7 receives the download request information. In step S107, the storing/reading processing unit 79 of the image storage device 7 reads the requested document image data from the storage unit 7000 based on the URLs received by the data exchange unit 71. In step S108, the data exchange unit 71 starts transmitting the requested document image data to the electronic whiteboard 1c, which is a request source terminal. Thereby, the data exchange unit 11c of the electronic whiteboard 1c starts downloading (receiving) the document image data. Further, in step S109, the data exchange unit 11c of the halfway participating terminal (electronic whiteboard 1c) transmits request information indicating a request for downloading stroke data to the communication management system 5. Thereby, the data exchange unit 51 of the communication management system 5 receives the request information. In step S110, the storing/reading processing unit 59 of the communication management system 5 searches the stroke data management table (FIG. 12) using the session ID as a search key, to read the stroke data generated during the remote conference. In this example, the storing/reading processing unit 59 reads the stroke data associated with the session ID “se01”. In step S111, the data exchange unit 51 starts transmitting the stroke data read in step S110 to the electronic whiteboard 1c. Thereby, the data exchange unit 11c of the electronic whiteboard 1c starts downloading (receiving) the stroke data.

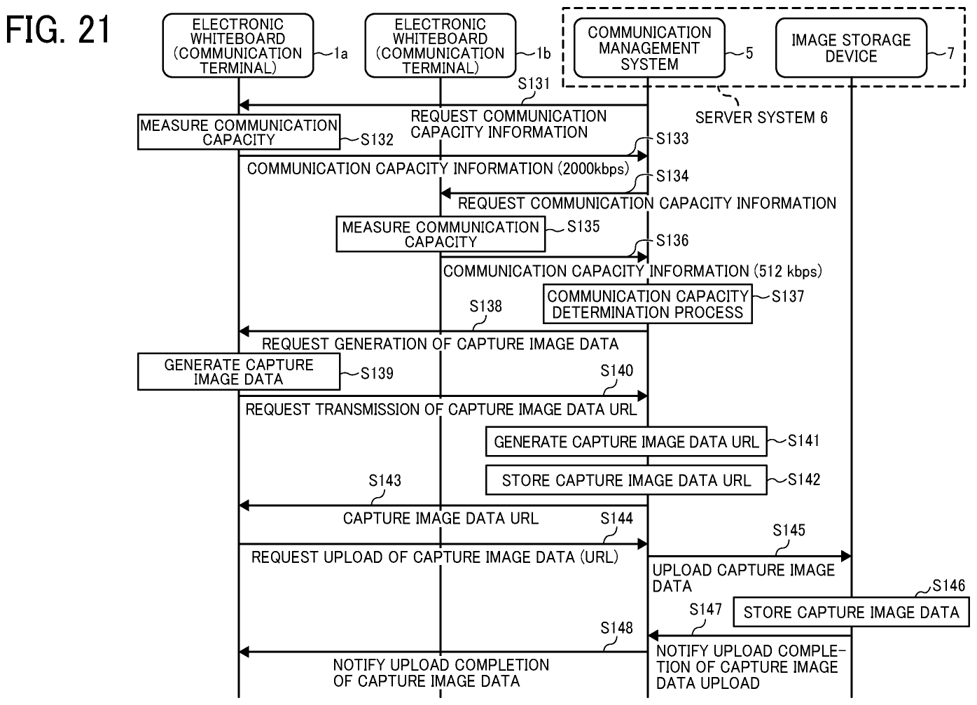

Now referring to FIG. 21, in step 131, the data exchange unit 51 of the communication management system 5 transmits a bandwidth information request indicating a request for bandwidth information to the electronic whiteboard 1a. Thereby, the data exchange unit 11a of the electronic whiteboard 1a receives the bandwidth information request. In step S132, the communication capacity measuring unit 16a of the electronic whiteboard 1a measures the communication bandwidth of the communication path through which the bandwidth information request is received. In step S133, the data exchange unit 11a transmits bandwidth information indicating information on the communication bandwidth measured by the communication capacity measuring unit 16a to the communication management system 5. In this example, the data exchange unit 11a transmits the bandwidth information indicating 2000 kbps, for example, as the communication bandwidth measured by the communication capacity measuring unit 16a. Thereby, the data exchange unit 51 of the communication management system 5 receives the bandwidth information.

Also, in step 134, the data exchange unit 51 of the communication management system 5 transmits a bandwidth information request indicating a request for bandwidth information to the electronic whiteboard 1b. Thereby, the data exchange unit 11b of the electronic whiteboard 1b receives the bandwidth information request. In step S135, the communication capacity measuring unit 16b of the electronic whiteboard 1b measures the communication bandwidth of the communication path through which the bandwidth information request is received. In step S136, the data exchange unit 11b transmits bandwidth information indicating information on the communication bandwidth measured by the communication capacity measuring unit 16b to the communication management system 5. In this example, the data exchange unit 11b transmits the bandwidth information indicating 512 kbps, for example, as the communication bandwidth measured by the communication capacity measuring unit 16b. Thereby, the data exchange unit 51 of the communication management system 5 receives the bandwidth information.

In step S137, the determination unit 55 of the communication management system 5 performs a bandwidth determination process using the bandwidth information received in steps S133 and S136. Specifically, the determination unit 55 identifies a communication terminal having the largest communication bandwidth based on the information on the communication bandwidths included in the received bandwidth information. In this example, since the communication bandwidth of the electronic whiteboard 1a is 2000 kbps and the communication bandwidth of the electronic whiteboard 1b is 512 kbps, the determination unit 55 identifies the electronic whiteboard 1a as the communication terminal having the largest communication bandwidth.

In step S138, the data exchange unit 51 of the communication management system 5 transmits a capture image data generation request indicating a request for generating capture image data, to the electronic whiteboard 1a, which is identified by the determination unit 55 as the communication terminal having the largest communication bandwidth. Thereby, the data exchange unit 11a of the electronic whiteboard 1a receives the capture image data generation request. In step S139, the image processing unit 17a of the electronic whiteboard 1a performs capturing of a screenshot displayed on the display 180 to generate capture image data. In the embodiment, the term “screenshot” refers to a display screen (still image or moving image) displayed on the display 180. The “capturing” refers to a process of acquiring the display screen displayed on the display 180 as image data. The capturing may be alternatively referred to as snapshot or image recognition. In step S140, the data exchange unit 11a transmits, to the communication management system 5, request information indicating a request for a URL indicating a storage location where the capture image data generated by the image processing unit 17a is stored. Thereby, the data exchange unit 51 of the communication management system 5 receives the request information.

In step S141, the generation unit 53 of the communication management system 5 generates a URL indicating a storage location in which the capture image data is to be stored. In step S142, the storing/reading processing unit 59 stores the URL generated by the generation unit 53 in the storage location information management DB 5007 (FIG. 13). In this example, the storing/reading processing unit 59 stores, in the storage location information management table, the URL generated by the generation unit 53 in association with an image ID (e.g., “m003”), which is newly assigned, and a data type “capture image”, as illustrated in FIG. 13. In step S143, the data exchange unit 51 transmits the URL indicating the storage location in which the capture image data is to be stored generated by the generation unit 53 to the electronic whiteboard 1a. Thereby, the data exchange unit 11a of the electronic whiteboard 1a receives the URL indicating the storage location at which the capture image data is to be stored.

In step S144, the data exchange unit 11a transmits an upload request indicating a request for uploading the capture image data to the communication management system 5. This upload request includes the capture image data and the URL indicating the storage location for the capture image data received in step S143. Thereby, the data exchange unit 51 of the communication management system 5 receives the upload request from the electronic whiteboard la. In step S145, the data exchange unit 51 of the communication management system 5 uploads the capture image data to the storage location of the image storage device 7 indicated by the URL included in the upload request received in step S144. Thereby, the data exchange unit 71 of the image storage device 7 receives the capture image data. In step S146, the storing/reading processing unit 79 of the image storage device 7 stores the capture image data in the storage location indicated by the URL in the storage unit 7000. In another example, the electronic whiteboard 1a may upload the capture image data directly to the storage location indicated by the URL at the image storage device 7 not through the communication management system 5.

In step S147, the data exchange unit 71 transmits an upload completion notice indicating that the upload of the capture image data has been completed to the communication management system 5. Thereby, the data exchange unit 51 of the communication management system 5 receives the upload completion notice. In step S148, the data exchange unit 51 of the communication management system 5 transfers the upload completion notice indicating that the upload of the capture image data has been completed to the electronic whiteboard 1a. Thereby, the data exchange unit 11a of the electronic whiteboard 1a receives the upload completion notice. In another example, the image storage device 7 may transmit the upload completion notice directly to the electronic whiteboard 1a not through the communication management system 5. In this case, in response to receiving the upload completion notice from the image storage device 7, the electronic whiteboard 1a transmits, to the communication management system 5, the upload completion notice including the URL indicating the storage location of the capture image data received in step S143.

Note that the processes of steps S131 to S137 illustrated in FIG. 21 may be omitted. For example, in a case where a time required for the processes of steps S131 to S137 illustrated in FIG. 21 exceeds a time required for the processes of steps S144 and S145 illustrated in FIG. 21, there is small effect of reducing the time required for uploading the capture image data. In this case, the communication management system 5 may transmit the capture image data generation request to any one of the electronic whiteboards 1 that are conducting the remote conference in step S138 of FIG. 21.

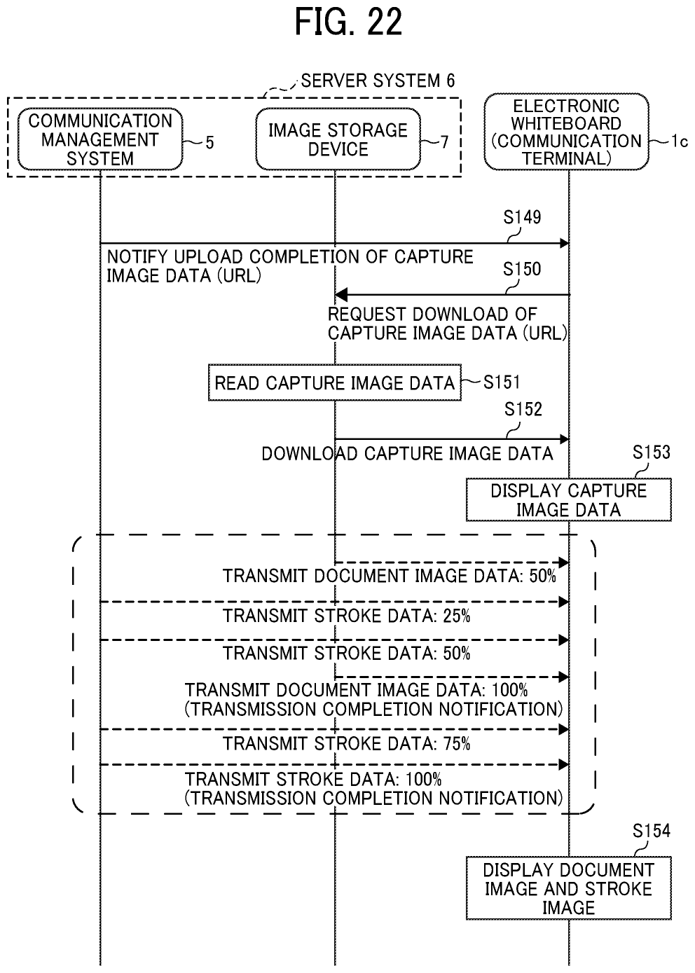

Now referring to FIG. 22, in step S149, the data exchange unit 51 of the communication management system 5 transfers the upload completion notice including the URL to the halfway participating terminal (electronic whiteboard 1c). Thereby, the data exchange unit 11c of the electronic whiteboard 1c receives the upload completion notice.

In step S150, the data exchange unit 11c of the electronic whiteboard 1c transmits download request information indicating a request for downloading the capture image data by accessing the URL received in step S149 indicating the storage location at the image storage device 7. Thereby, the data exchange unit 71 of the image storage device 7 receives the download request information.

In step S151, the storing/reading processing unit 79 of the image storage device 7 reads the capture image data, which is a request target, from the storage unit 7000 based on the URL. In step S152, the data exchange unit 71 transmits the requested capture image data to the electronic whiteboard 1c as the request source terminal. Thereby, the data exchange unit 11c of the electronic whiteboard 1c downloads (receives) the capture image data. In step S153, the display control unit 14c of the electronic whiteboard 1c controls the display 180 to display a capture image h1 as illustrated in FIG. 23. The display image illustrated in FIG. 23 includes the capture image h1, which is generated by the electronic whiteboard 1a, and a notification image ml indicating that download of document image data and stroke data is in progress.

Thus, the user C1 of the electronic whiteboard 1c recognizes that download of the document image data and the stroke data is in progress as well as grasps the outline of the remote conference so far from the capture image h1. The notification image ml illustrated in FIG. 23 is just example, and any image, text, icon, or a combination thereof can be used provided that it can notify the user C1 that data is being downloaded. For example, the notification image m1 can be an indicator indicating the progress of the download, a numerical value of the percentage (%) of the downloaded data, or an hourglass icon. The notification image m1 is an example of a predetermined message indicating that the download of the stroke data is in progress.

Note that the order of the processing from step S104 to S110 and the processing from steps S131 to S153 may be reversed or may be executed in parallel.

Further, the electronic whiteboard 1c downloads document image data and stroke data, while displaying the display image illustrated in FIG. 23 on the display 180. Since the communication management system 5 stores a plurality pieces of stroke data generated during the remote conference, and the data size of the plurality of pieces of stroke data to be downloaded is large. It takes more time to download stroke data than it does to download capture image data as described above and document image data from the image storage device 7. For this reason, the electronic whiteboard 1c displays the display image as illustrated in FIG. 23 on the display 180 until the download of all the stroke data is completed.

When download of the document image data is completed, the data exchange unit 11c of the electronic whiteboard 1c receives, from the image storage device 7, a document image data transmission completion notice indicating that download of the document image data is completed. Further, when download of the plurality pieces of stroke data is completed, the data exchange unit 11c of the electronic whiteboard 1c receives a stroke data transmission completion notice indicating that download of the plurality of pieces of stroke data is completed. For example, the document image data transmission completion notice is transmitted in the same packet as the document image data. Alternatively, the document image data transmission completion notice may be transmitted in the different packet from a packet in which the document image data is transmitted. Similarly, for example, the stroke data transmission completion notice is transmitted in the same packet as the plurality of pieces of stroke data. Alternatively, the stroke data transmission completion notice may be transmitted in the different packet from a packet in which the plurality of pieces of stroke data is transmitted.

In step S154, in response to receiving the document image data transmission completion notice and the stroke data transmission completion notice by the data exchange unit 11c, the display control unit 14c of the electronic whiteboard 1c controls the display 180 to display an image obtained by combining the document image d2 and the stroke images (st1 to st5) as illustrated in FIG. 24, replaced with the capture image h1 as illustrated in FIG. 23. The display image illustrated in FIG. 24 includes the document image d2 based on the document image data transmitted from the image storage device 7 and the stroke images st1 to st5 based on the stroke data transmitted from the communication management system 5.

The display image illustrated in FIG. 24 is configured by a layer for a stroke image and a layer for a document image, as illustrated in FIG. 25. The display image illustrated in FIG. 24 is obtained by superimposing the stroke image as a first layer (closest layer viewed from a user) on the document image as a second layer (second closest layer viewed from the user). The stroke image is, for example, an image including drawing data received by the acceptance unit 12. The document image is an image including image data displayed on the display 180, and is an image arranged at the rearmost plane of the superimposed images. The electronic whiteboard 1c controls the display 180 to display the display image (shared image) including the document image d2 and the stroke images st1 to st5 as illustrated in FIG. 24, and thereby making it possible to perform stroke drawing to be shared with other electronic whiteboards 1 at different sites.

As described heretofore, the halfway participating terminal (electronic whiteboard 1c) downloads document image data corresponding to a document image displayed on the electronic whiteboard 1a from the image storage device 7, and downloads stroke data corresponding to stroke images drawn on the electronic whiteboard 1a and the electronic whiteboard 1b from the communication management system 5. Further, the halfway participating terminal (electronic whiteboard 1c) downloads capture image data obtained by capturing a display screen displayed on the electronic whiteboard 1a or the electronic whiteboard 1b from the image storage device 7. While download of the document image data and the stroke data is in progress, the halfway participating terminal (electronic whiteboard 1c) controls the display 180 to display the capture image h1 corresponding to the capture image data. When the download of the document image data and the stroke data is completed, the electronic whiteboard 1c replaces the capture image h1 displayed on the display 180 with the stroke images st1 to st5) and the document image d2.

In order to cause the halfway participating terminal (electronic whiteboard 1c) to display a shared image shared in a remote conference, all the records of document image data and stroke data generated in the remote conference have to be transmitted to the electronic whiteboard 1c. For example, since the halfway participating terminal has to download all the records of stroke data to reproduce the state of the shared image, it takes a very long time for the halfway participating terminal to draw stroke images corresponding all pieces of stroke data. To address this issue, in the present embodiment, when the electronic whiteboard 1c joins part way through a remote conference, the electronic whiteboard 1c controls the display 180 to display the capture image h1, which is obtained by capturing the display screen displayed on the electronic whiteboard 1a (or the electronic whiteboard 1b), until download of stroke data is completed. Thus, the communication system according to the present embodiment can reduce the time to display an image representing the current state of the remote conference (a display screen displayed on other communication terminals) on the halfway participating terminal. This enables the user of the halfway participating terminal join the conference smoothly, thereby reducing the risk of inconsistency in communication.

Further, based on the bandwidth information indicating the communication bandwidths of the electronic whiteboard 1a and the electronic whiteboard 1b that are conducting the remote conference, the communication management system 5 requests the electronic whiteboard 1 (e.g., the electronic whiteboard 1a), which has a larger communication bandwidth, to generate capture image data obtained by capturing a display screen displayed on the electronic whiteboard 1a. In response to receiving the request from the communication management system 5, the electronic whiteboard 1a uploads the obtained capture image data to the image storage device 7. The halfway participating terminal downloads the uploaded capture image data from the image storage device 7. This reduces the time required for uploading the capture image data to the image storage device 7, thereby further reducing the time to display the capture image h1 on the halfway participating terminal.

Furthermore, the description given with reference to FIG. 20 to FIG. 25 is of the operation performed when document image data and stroke data generated during a remote conference conducted between the electronic whiteboard 1a and the electronic whiteboard lb are shared to the halfway participating terminal (electronic whiteboard 1c). However, the operation illustrated in FIG. 20 to FIG. 25 is not limited to the operation for the communication terminal that is to join part way through the remote conference. For example, the operation illustrated in FIG. 20 to FIG. 25 can be performed to share document image data and stroke data displayed on the display 180 of the starting terminal (electronic whiteboard 1a) before the start of a remote conference with the destination terminal (electronic whiteboard 1b or electronic whiteboard 1c) at the start of the remote conference. In this case, at the time of establishing a communication session between the starting terminal and the destination terminal, the starting terminal uploads the document image data and the stroke data to the server system 6, and the destination terminal downloads the document image data and the stroke data uploaded to the server system 6.

As described heretofore, the electronic whiteboard 1c (an example of a communication terminal) according to an embodiment of the present disclosure is a communication terminal that shares data with another communication terminals (e.g., the electronic whiteboard 1a or the electronic whiteboard 1b). The electronic whiteboard 1c starts downloading a plurality of stroke data items corresponding to a plurality of stroke images drawn on the other communication terminal from the communication management system 5 that stores data to be shared between with communication terminal and the other communication terminal. The electronic whiteboard 1c also receives capture image data obtained by capturing a display screen displayed on the other communication terminal by the other communication terminal, from the image storage device 7 that stores the capture image data. When download of the plurality of stroke data items is not completed, the electronic whiteboard 1c controls the display 180 (an example of a display unit) to display the capture image h1 corresponding to the received capture image data. When the download of the plurality of stroke data items is completed, the electronic whiteboard 1c controls the display 180 to display the plurality of stroke images (st1 to st5) corresponding to the received plurality of stroke data items, replaced with the capture image h1. Thus, the electronic whiteboard 1c displays the display screen (capture image h1) displayed on the other communication terminal until the download of the stroke data is completed. This enables the user of the electronic whiteboard 1c join the remote conference smoothly, thereby reducing the risk of inconsistency in communication.

Further, the electronic whiteboard 1c (an example of a communication terminal) according to an embodiment of the present disclosure receives, from the communication management system 5, a URL (an example of storage location information) indicating a storage location where document image data corresponding to a document image displayed on another communication terminal (e.g., the electronic whiteboard 1a or the electronic whiteboard 1b), and transmits a download request for the document image data to the storage location indicated by the received URL at the image storage device 7. The electronic whiteboard 1c starts downloading the document image data that is transmitted from the image storage device 7 in response to the download request. When the download of the plurality of stroke data items is completed and the download of the document image data is completed, the electronic whiteboard 1c controls the display 180 to display the plurality of stroke images (st1 to st5) superimposed on the document image data d2, in place of the capture image h1. Thus, the electronic whiteboard 1c displays the display screen (capture image h1) displayed on the other communication terminal until the download of the document image data and the stroke data is completed, and when the download is completed, displays on the electronic whiteboard 1c a shared image on which a stroke to be shared with the other communication terminal can be drawn. Accordingly, the communication terminal displays various types of images based on various types of data shared between a plurality of communication terminals in a suitable manner, thereby implementing smooth communication.

Furthermore, the electronic whiteboard 1c (an example of a communication terminal) according to an embodiment of the present disclosure displays, from the start to the completion of download of the plurality of stroke data items, a notification image m1 (an example of a predetermined message) indicating that the download of a plurality of stroke data items is in progress. Thus, the user C1 of the electronic whiteboard 1c recognizes that download of the stroke data is in progress as well as grasps the current status of the remote conference from the capture image h1.

A communication system according to an embodiment of the present disclosure includes an electronic whiteboard 1c (an example of a communication terminal), another communication terminal (e.g., the electronic whiteboard 1a or the electronic whiteboard 1b), and the communication management system 5. The communication management system 5 transmits a capture image data generation request to the other communication terminal in response to a request from the electronic whiteboard 1c. The other communication terminal transmits the capture image data generated in response to the generation request transmitted from the communication management system 5 to the image storage device 7. Thus, when the electronic whiteboard 1c joins part way through a remote conference, the communication system according to an embodiment of the present disclosure allows the other communication terminal to upload the capture image data generated by the other communication terminal to the image storage device 7. Thereby, the communication system allows the electronic whiteboard 1c to acquire an image (a display screen displayed on the other communication terminal) indicating the current state of the remote conference and to display the acquired image on the electronic whiteboard 1c.

Furthermore, the communication system according to an embodiment of the present disclosure includes a plurality of other communication terminals (e.g., the electronic whiteboard 1a and the electronic whiteboard 1b). Each of the plurality of other communication terminals transmits bandwidth information indicating a communication bandwidth used for sharing data to the communication management system 5. The communication management system 5 transmits a generation request requesting generation of capture image data to a particular communication terminal (e.g., the electronic whiteboard 1a) of the plurality of other communication terminals, the particular communication terminal having the largest communication bandwidth indicated by the bandwidth information transmitted from the plurality of other communication terminals. The particular communication terminal transmits the capture image data generated in response to the generation request transmitted from the communication management system 5 to the image storage device 7. Accordingly, the communication system according to an embodiment of the present disclosure reduces the time required for uploading the capture image data to the image storage device 7, thereby further reducing the time to display the capture image h1 on the electronic whiteboard 1c.

Variations:

In the above-described embodiment, an office device that is an electronic whiteboard has been described as an example of a communication terminal, however, the communication terminal in the present disclosure is not limited to the office devices. Other examples of the communication terminal include a PC, a smartphone, a smartwatch, a car navigation system, a telepresence robot. Further, the communication terminal includes a medical device. In a case where the communication terminal is a medical device, the document image is a patient image.

When a number of stroke images are being drawn at a counterpart communication terminal, it takes time for a communication terminal to download all the stroke data generated during the remote conference. During such download time, the communication terminal cannot display a shared image that is to be shared with the counterpart communication terminal. Therefore, the user of the communication terminal cannot check the shared image to be shared with the counterpart communication terminal until all the stroke data has been downloaded. This may degrade smoothness of communication between the user of the communication terminal and the user of the counterpart communication terminal.

According to one or more embodiments, a communication terminal displays various types of images based on various types of data shared between a plurality of communication terminals in a suitable manner. This contributes to implementation of smooth communication.

Further, in the above embodiment, a case where the videoconference is performed by the communication system has been described. However, the present disclosure is not limited to this case and may be used for meetings, general conversations between family members, friends, remote diagnosis, or presentation of information in one direction.

The functions of each embodiment can be implemented by a computer executable program described in a legacy programming language such as assembler, C, C++, C#, Java (registered trademark) or an object-oriented programming language, etc. Programs for executing the functions of each embodiment can be distributed through telecommunication lines.

The programs for executing the functions of the embodiments may be stored and distributed on equipment readable recording media such as a ROM, an electrically erasable programmable read-only memory (EEPROM), an erasable programmable read-only memory (EPROM), a flash memory, a flexible disc, a compact disc-read only memory (CD-ROM), a compact disc-rewritable (CD-RW), a digital versatile disc-read only memory (DVD-ROM), a digital versatile disc-random access memory (DVD-RAM), a digital versatile disc-rewritable (DVD-RW), a Blu-ray disc (registered trademark), a Secure Digital (SD) card, a magneto-optical (MO) disc, and the like.

In addition, some or all of the functions of the embodiments may be mounted on a programmable device (PD) such as a field programmable gate array (FPGA) or implemented as an application specific integrated circuit (ASIC), and distributed by the recording medium as a circuit configuration data (bit stream data) downloaded to the PD in order to implement the functions of the embodiments on the PD, or as data described by Hardware Description Language (HDL), Very High Speed Integrated Circuits Hardware Description Language (VHDL), Verilog-HDL, etc. for generating circuit configuration data.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A communication terminal communicable with another communication terminal, the communication terminal comprising circuitry configured to:
start a download of a plurality of stroke data items corresponding to a plurality of stroke images drawn at the another communication terminal from a communication management system that stores data to be shared between the communication terminal and the another communication terminal;
receive capture image data obtained by capturing a display screen displayed at the another communication terminal by the another communication terminal, from an image storage device that stores the capture image data;
when the download of the plurality of stroke data items is not completed, control a display of the communication terminal to display a capture image corresponding to the received capture image data; and
when the download of the plurality of stroke data items is completed, control the display to switch an image to be displayed on the display from the capture image currently being displayed to the plurality of stroke images corresponding to the downloaded plurality of stroke data items.

2. The communication terminal of claim 1, wherein the circuitry is further configured to:
receive, from the communication management system, storage location information indicating a storage location where document image data corresponding to a document image displayed on the another communication terminal is stored;
transmit a download request that requests a download of the document image data, to the storage location at the image storage device indicated by the received storage location information;
start a download of the document image data that is transmitted from the image storage device in response to the download request; and
when the download of the plurality of stroke data items is completed and the download of the document image data is completed, control the display to display the plurality of stroke images and the document image.

3. The communication terminal of claim 2, wherein
the circuitry is further configured to, when the download of the plurality of stroke data items is completed and the download of the document image data is completed, control the display to switch the image to be displayed on the display from the capture image currently being displayed to the plurality of stroke images and the document image.

4. The communication terminal of claim 2, wherein
the circuitry is further configured to control the display to display the plurality of stroke images superimposed on the document image.

5. The communication terminal of claim 1, wherein
the circuitry is further configured to display a predetermined message indicating that the download of a plurality of stroke data items is in progress, from when the download of the plurality of stroke data items is started until when the download of the plurality of stroke data items is completed.

6. A communication system, comprising:
the communication terminal of claim 1;
another communication terminal communicable with the communication terminal; and
a communication management system that stores data shared between the communication terminal and the another communication terminal.

7. The communication system of claim 6,
wherein the another communication terminal is configured to:
transmit a plurality of stroke data items corresponding to a plurality of stroke images drawn at the another communication terminal to the communication management system; and
transmit document image data corresponding to a document image displayed on the another communication terminal to an image storage device.

8. The communication system of claim 6,
wherein the communication management system transmits a generation request requesting a generation of capture image data to the another communication terminal in response to a request from the communication terminal, and
wherein the another communication terminal transmits the capture image data generated in response to the generation request to the image storage device.

9. The communication system of claim 6, further comprising:
a plurality of other communication terminals including the another communication terminal,
wherein each of the plurality of other communication terminals transmits bandwidth information indicating a communication bandwidth available to share the data to the communication management system,
wherein the communication management system transmits a generation request requesting a generation of capture image data to a particular communication terminal having a largest communication bandwidth indicated by the bandwidth information transmitted from the plurality of other communication terminals, and
wherein the particular communication terminal transmits the capture image data to the image storage device.

10. A display control method performed by a communication terminal communicable with another communication terminal, the method comprising:
starting a download of a plurality of stroke data items corresponding to a plurality of stroke images drawn at the another communication terminal from a communication management system that stores data to be shared between the communication terminal and the another communication terminal;
receiving capture image data obtained by capturing a display screen displayed at the another communication terminal by the another communication terminal, from an image storage device that stores the capture image data;
controlling a display of the communication terminal to display a capture image corresponding to the received capture image data when the download of the plurality of stroke data items is not completed; and
controlling the display to switch an image to be displayed on the display from the capture image currently being displayed to the plurality of stroke images corresponding to the downloaded plurality of stroke data items, when the download of the plurality of stroke data items is completed.
